(19) United States
(12) Patent Application Publication
(10) Pub. No.: US 2017/0059467 A1
(43) Pub. Date: Mar. 2, 2017

(54) SYSTEMS AND METHODS FOR MEASURING RELATIVE PERMEABILITY FROM UNSTEADY STATE SATURATION PROFILES

(71) Applicant: Board of Regents, The University of Texas System, Austin, TX (US)

(72) Inventors: David A. DiCarlo, Austin, TX (US); Amir Kianinejad, Austin, TX (US)

(21) Appl. No.: 15/248,117

(22) Filed: Aug. 26, 2016

Related U.S. Application Data
(60) Provisional application No. 62/210,156, filed on Aug. 26, 2015.

(51) Int. Cl. G01N 15/08; G01N 23/04

(52) U.S. Cl. CPC G01N 15/082; G01N 23/046; G01N 2223/419

(57) ABSTRACT

An example system for obtaining relative permeability from unsteady state saturation profiles is described herein. The system can include a pressure source configured to inject a first fluid into a core, and a nondestructive test (NDT) device configured to measure a saturation profile of a second fluid along the core. The saturation profile of the second fluid can be measured at each of a plurality of times. The system can also include a processor and a memory in operative communication with the processor. The processor can be configured to estimate one or more parameters related to conditions of the core directly from the respective saturation profiles, and calculate the relative permeability using the one or more parameters.

### CROSS-REFERENCE TO RELATED APPLICATIONS

This application claims the benefit of U.S. Provisional Patent Application No. 62/210,156, filed on Aug. 26, 2015, entitled “SYSTEMS AND METHODS FOR MEASURING RELATIVE PERMEABILITY FROM UNSTEADY STATE SATURATION PROFILES,” the disclosure of which is expressly incorporated herein by reference in its entirety.

### STATEMENT REGARDING FEDERALLY FUNDED RESEARCH

This invention was made with government support under Grant no. DE-SC0001114 awarded by the Department of Energy. The government has certain rights in the invention.

### BACKGROUND

Relative permeability measurements are difficult, time consuming, and expensive endeavors (Grader and O'Meara Jr 1988; Honarpour and Mahmood 1988; Oak, Baker, and Thomas 1990). Moreover, the obtained data are sometimes not representative of the exact processes occurring in the reservoirs due to limitations, interpretations, and assumptions attributed to each measurement method (Geffen et al. 1951; Richardson et al. 1952; Jones and Roszelle 1978; Oak 1990; Mohanty and Miller 1991; Fassihi and Potter 2009).

The steady-state method was the first method proposed for two- and later three-phase relative permeability measurement as the standard method for this purpose (Osoba et al. 1951; Geffen et al. 1951; Richardson et al. 1952; Braun and Blackwell 1981). However, this method is time consuming, expensive, and only provides a limited number of points on the relative permeability curve. In addition, careful attention must be paid into design of these experiments to minimize the saturation gradients at the outlet side of the core due to capillary end effects (Osoba et al. 1951; Richardson et al. 1952; Rapoport and Leas 1953).

As an alternative for faster measurements, unsteady-state methods were proposed with more complicated formulations (Welge 1950; Johnson, Bossier, and Naumann 1959; Sarem 1966; Saraf et al. 1982; Virnovskii 1984; Grader and O'Meara Jr 1988; Siddiqui, Hicks, and Grader 1996). These methods allow the phase saturations to change naturally. Consequently, these methods can potentially mimic the processes occurring in the reservoirs better than steady-state methods in which fluids are introduced into the core at pre-determined flow rates. However, the calculation of relative permeability from conventional unsteady-state experiments require assumptions and interpretations of the measured pressure drops and effluent fractional flows which may not necessarily hold (Mohanty and Miller 1991). Particularly, the measured fractional flows in the effluent may be altered by capillary end effects. This is on top of the pressures across the core which may not be the right pressure gradients inside the core, as majority of the pressure drop occurs at the outlet of the core due to capillary end effects (Geffen et al. 1951; Osoba et al. 1951; Richardson et al. 1952; Rapoport and Leas 1953).

It is also possible to calculate relative permeabilities by history matching the pressure/production data, and/or in-situ saturation profiles measured during unsteady-state flooding experiments (Maini and Batycky 1985; Maini and Okazawa 1987; Vizika and Lombard 1996). However, the calculated relative permeabilities according to these methods are susceptible to errors due to local heterogeneity and capillarity. In addition, the resulted relative permeability curves are not unique, a characteristics of inverse problem solving method (Sigmund and McCaffery 1979; Kerig and Watson 1987).

Recently, Sahni and others (Naylor et al. 1996; Sahni, Burger, and Blunt 1998; DiCarlo, Akshay, and Blunt 2000; Dicarlo, Sahni, and Blunt 2000; H. Dehghanpour et al. 2011; Hassan Dehghanpour and DiCarlo 2013; Kianinejad et al. 2014) proposed methods for obtaining relative permeabilities from saturation profiles during gravity drainage experiments, far from the saturation shock front in vertical sandpacks. According to these methods, if particular criteria are met, the capillary pressure gradients can be neglected and relative permeabilities can be obtained directly from in-situ saturation profiles. Using these methods, relative permeabilities can be obtained over a range of saturations, as opposed to other methods which only provide a limited number of points over the saturation space. However, these methods are only applicable to unconsolidated sandpacks with low capillary forces. In addition, using these methods, the saturation path of experiments in three-phase space is chosen by nature (i.e., there is no control over the saturation path). Further, these methods only obtain relative permeabilities at low saturations (S<0.3), due to fast saturation changes at early times of the experiments.

### SUMMARY

An example system for obtaining relative permeability from unsteady state saturation profiles is described herein. The system can include a pressure source configured to inject a first fluid into a core, and a nondestructive test (NDT) device configured to measure a saturation profile of a second fluid along the core. The saturation profile of the second fluid can be measured at each of a plurality of times. The system can also include a processor and a memory operably coupled with the processor. The processor can be configured to estimate one or more parameters related to conditions of the core directly from the respective saturation profiles, and to calculate the relative permeability using the one or more parameters.

Additionally and optionally, the pressure source can be further configured to inject the first fluid at a pressure greater than an entry capillary pressure of the core.

Additionally and optionally, the parameters can include at least one of a fluid flux, a gas pressure gradient, or a capillary pressure gradient. Optionally, the parameters can include a gas pressure gradient.

Additionally and optionally, the parameters can be estimated for a region of the core where the respective saturation profiles meet predetermined criteria. Optionally, the respective saturation profiles in the region of the core can be spatially uniform and can have small saturation gradients. Alternatively or additionally, a capillary pressure gradient in the region of the core can optionally be less than a sum of a gas pressure gradient in the region of the core and a gravitational gradient. Optionally, a ratio of the capillary pressure gradient to the sum of the gas pressure gradient and the gravitational gradient can be less than about 0.2.

Additionally and optionally, the NDT device can be a computed tomography (CT) imaging system.

Optionally, the first fluid can be gas. Optionally, the pressure source can be a gas pressure regulator. Alternatively or additionally, the second fluid can be at least one of gas, oil, or water. In some implementations, the second fluid can be water (e.g., a two-phase implementation). In other implementations, the second fluid can be a plurality of fluids such as water and oil (e.g., a three-phase implementation). Optionally, the system can further include a second pressure source configured to inject water into the core.

Additionally and optionally, the relative permeability can be a multi-phase relative permeability.

Additionally and optionally, the core defines an entry end and an exit end. Optionally, the first fluid can be injected into the entry end of the core. Alternatively or additionally, the second fluid can drain by gravity from the exit end of the core.

Additionally and optionally, the core can be permeable rock.

An example method for obtaining relative permeability from unsteady state saturation profiles is described herein. The method can include injecting a first fluid into a core, measuring a respective saturation profile of a second fluid along the core at each of a plurality of times, estimating one or more parameters related to conditions of the core directly from the respective saturation profiles, and calculating the relative permeability using the one or more parameters.

Optionally, the first fluid can be injected at a pressure greater than an entry capillary pressure of the core.

Additionally and optionally, the parameters can include at least one of a fluid flux, a gas pressure gradient, or a capillary pressure gradient. Optionally, the parameters can include a gas pressure gradient.

Additionally and optionally, the parameters can be estimated for a region of the core where the respective saturation profiles meet predetermined criteria. Optionally, the respective saturation profiles in the region of the core can be spatially uniform and can have small saturation gradients. Alternatively or additionally, a capillary pressure gradient in the region of the core can optionally be less than a sum of a gas pressure gradient in the region of the core and a gravitational gradient. Optionally, a ratio of the capillary pressure gradient to the sum of the gas pressure gradient and the gravitational gradient can be less than about 0.2.

Additionally and optionally, the method can further include neglecting a capillary pressure gradient when the respective saturation profiles meet predetermined criteria.

Additionally and optionally, the respective saturation profiles can be measured using a nondestructive testing (NDT) technique. For example, the NDT technique can be computed tomography (CT) imaging.

Optionally, the first fluid can be gas. Alternatively or additionally, the second fluid can be at least one of gas, oil, or water. In some implementations, the second fluid can be water (e.g., a two-phase implementation). In other implementations, the second fluid can be a plurality of fluids such as water and oil (e.g., a three-phase implementation). Optionally, the method can further include injecting water into the core.

Additionally and optionally, the relative permeability can be a multi-phase relative permeability.

Additionally and optionally, the core defines an entry end and an exit end. Optionally, the first fluid can be injected into the entry end of the core. Alternatively or additionally, the second fluid can drain by gravity from the exit end of the core.

Additionally and optionally, the core can be permeable rock.

Another method for obtaining relative permeability from unsteady state saturation profiles is described herein. The method can include receiving a plurality of saturation profiles of a fluid along a permeable rock core, where each of the saturation profiles is measured at a different time. The method can also include estimating one or more parameters related to conditions of the core directly from the saturation profiles, and calculating the relative permeability using the one or more parameters. The parameters can be estimated for a region of the core where the saturation profiles meet predetermined criteria.

Optionally, the respective saturation profiles in the region of the core can be spatially uniform and can have small saturation gradients. Alternatively or additionally, a capillary pressure gradient in the region of the core can optionally be less than a sum of a gas pressure gradient in the region of the core and a gravitational gradient. Optionally, a ratio of the capillary pressure gradient to the sum of the gas pressure gradient and the gravitational gradient can be less than about 0.2.

Additionally and optionally, the method can further include neglecting a capillary pressure gradient when the respective saturation profiles meet predetermined criteria.

Additionally and optionally, the parameters can include at least one of a fluid flux, a gas pressure gradient, or a capillary pressure gradient. Optionally, the parameters can include a gas pressure gradient.

Additionally and optionally, the fluid can be at least one of gas, oil, or water. In some implementations, the fluid can be a plurality of fluids such as gas and water (e.g., a two-phase implementation). In other implementations, the fluid can be a plurality of fluids such as gas, water, and oil (e.g., a three-phase implementation). Optionally, the method can further include injecting water into the core.

Additionally and optionally, the relative permeability can be a multi-phase relative permeability.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A is a block diagram of an example system for obtaining relative permeability from unsteady state saturation profiles according to implementations described herein.

FIG. 1B illustrates an example permeable rock core that can be used with the example system of FIG. 1A.

FIG. 1C illustrates an example pressure source that can be used with the example system of FIG. 1A.

FIG. 1D illustrates an example system for obtaining relative permeability from unsteady state saturation profiles according to implementations described herein.

FIG. 2A is an example computing device.

FIG. 2B is a flow chart illustrating example operations for obtaining relative permeability from unsteady state saturation profiles.

FIG. 3 is a graph illustrating the CT measured porosity along the example core.

FIG. 4 is a graph that shows the measured capillary pressure curve and its Brooks-Corey fit to the experimental data after converting the raw data to the water-gas system using corrections.

FIG. 5 is a graph that shows the water saturation profile along the core during the primary drainage (S_{wi}=1) experiment (two-phase study Test 1) of fully water saturated core while gas is being injected at 1.2 psig (8.27 kPa) from the top of the core.

FIG. 6 is a graph that shows the secondary water/gas drainage experiment (two-phase study Test 2) with gas being injected at 3.78 psig (26.06 kPa).

FIG. 7 is a graph that shows the saturation profile during two-phase study Test 3 where the gas is injected at 6.13 psig.

FIG. 8 is a graph that shows the saturation profile during two-phase study Test 4 where the gas is injected at 8.96 psig.

FIG. 9 is a graph that shows the saturation profile during two-phase study Test 5 where the gas is injected at 8.96 psig.

FIGS. 10A-10C are graphs that show the gas pressure along the core at different times for gas injection pressures of 3.78 psig (i.e., FIG. 10A), 6.13 psig (i.e., FIG. 10B), and 8.96 psig (i.e., FIG. 10C), respectively.

FIG. 11 is a graph that shows the obtained water relative permeability for two-phase study Test 3, where the gas is being injected at 3.78 psig.

FIG. 12 is a graph that shows the obtained water relative permeability for two-phase study Test 4.

FIG. 13 is a graph that shows the obtained water relative permeability for two-phase study Test 5.

FIG. 14 is a graph that shows the relative permeability data obtained for two-phase study Test 2, which used the lowest gas injection pressure.

FIG. 15 is a graph that shows all the relative permeabilities shown in FIGS. 11-14 in a single plot on a linear scale.

FIG. 16 is a graph that shows all the relative permeabilities shown in FIGS. 11-14 in a single plot on a log scale as a function of water saturation.

FIG. 17 is a graph that shows water relative permeability calculated based only on fluid gravity as a driving force (i.e., neglecting both capillary and gas pressure gradients).

FIG. 18 is a graph that shows four sets of published water relative permeability data of Berea core samples using conventional steady-state techniques along with the water relative permeability measured using the unsteady-state techniques described herein (Oak, Baker, and Thomas 1990; Perrin and Benson 2010; Krevor et al. 2012; Akbarabadi and Piri 2013) on a linear scale.

FIG. 19 is a graph that shows four sets of published water relative permeability data of Berea core samples using conventional steady-state techniques along with the water relative permeability measured using the unsteady-state techniques described herein (Oak, Baker, and Thomas 1990; Perrin and Benson 2010; Krevor et al. 2012; Akbarabadi and Piri 2013) on a log scale.

FIG. 20 illustrates the saturation path of three-phase study Tests 1-3 on three-phase saturation space.

FIG. 21A is a graph that show the water saturation profile along the core during three-phase study Test 1. FIG. 21B is a graph that show the oil saturation profile along the core during three-phase study Test 1.

FIG. 22A is a graph that shows the three-phase oil relative permeability data obtained from three-phase study Test 1. FIG. 22B is a graph that shows the three-phase oil relative permeability data obtained from three-phase study Test 2. FIG. 22C is a graph that shows the three-phase oil relative permeability data obtained from three-phase study Test 3.

FIG. 23 is a graph that shows plots all of the data shown in FIGS. 22A-22C in a single plot.

FIG. 24 is a graph that shows the measured data of FIG. 23 and their respective Corey-type fits.

FIG. 25 is a graph that shows the residual oil saturation as a function of final water saturation of the system for three-phase study Tests 1-3.

FIG. 26 is a graph that shows measured three-phase oil relative permeability as a function of normalized oil saturation and the corresponding Corey model fit.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. While implementations will be described for obtaining relative permeability from unsteady state saturation profiles, it will become evident to those skilled in the art that the implementations are not limited thereto.

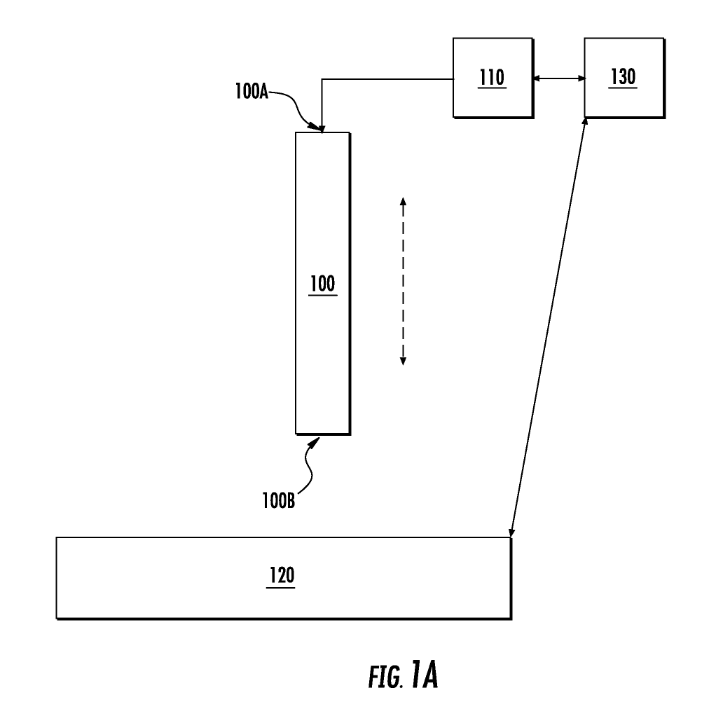

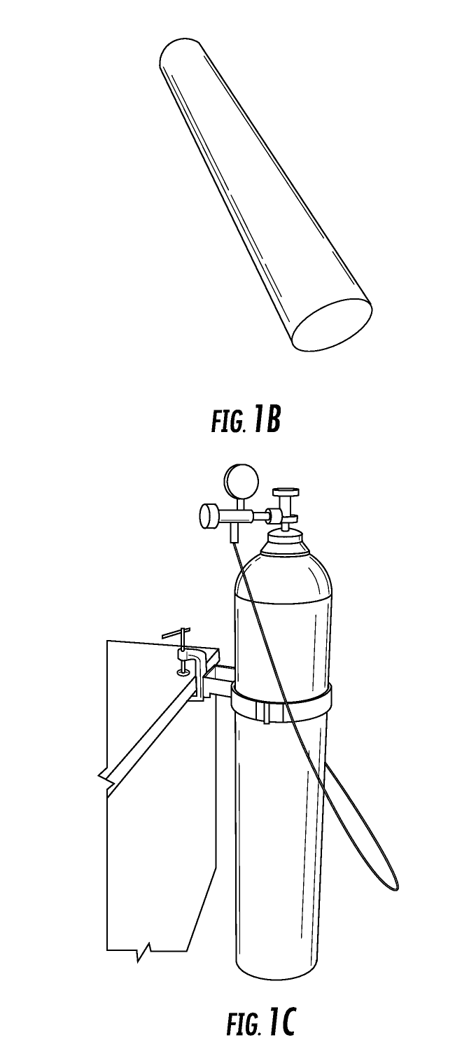

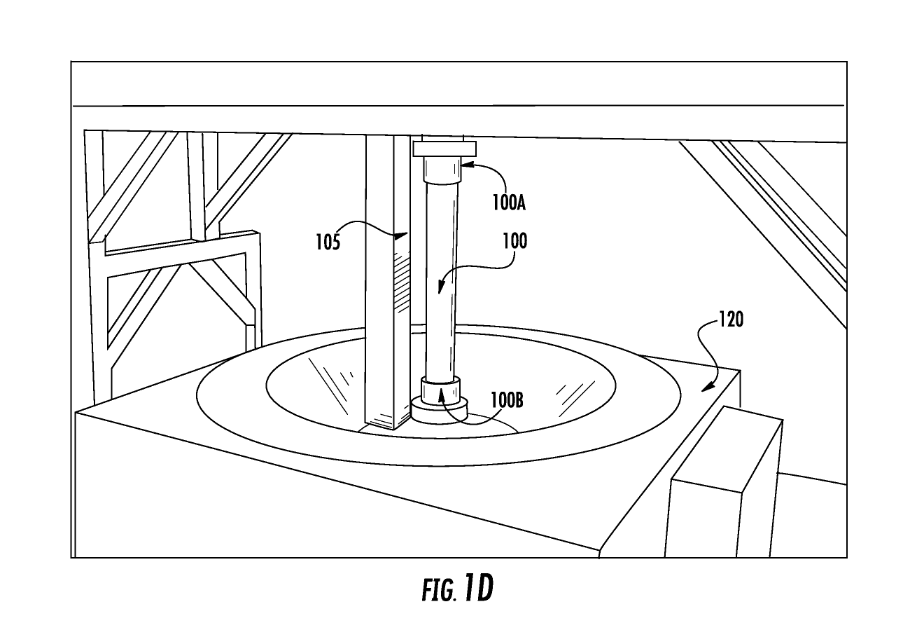

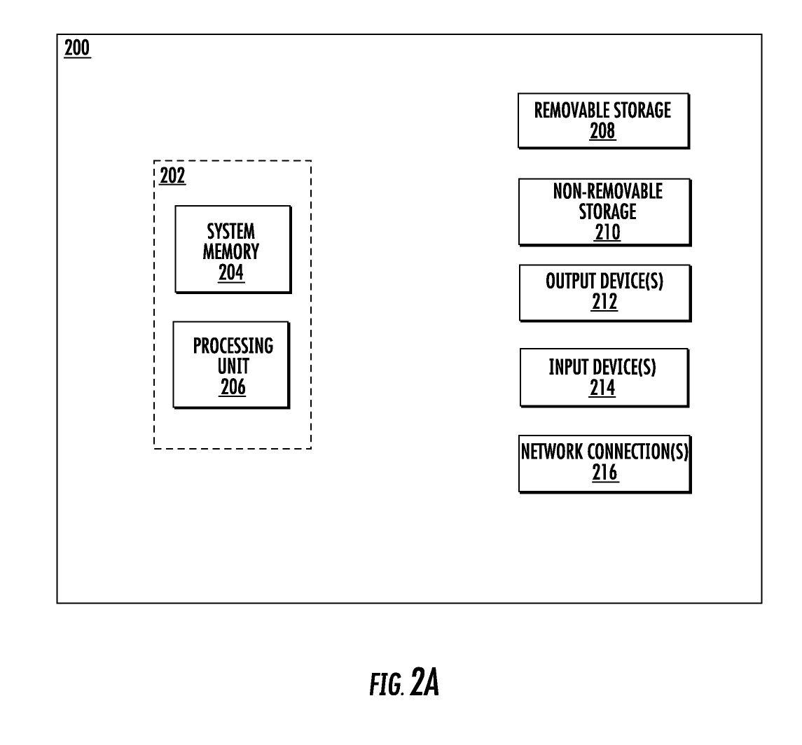

Referring now to FIGS. 1A-1D, an example system for obtaining relative permeability from unsteady state saturation profiles is shown. As shown in FIGS. 1A and 1D, the system includes a core 100. The core 100 can optionally be permeable rock (e.g., non-sandpack). For example, the core 100 can optionally be a sample obtained from the field, for example, from a formation that contains a desirable fluid such as oil and/or gas. It should be understood that the core 100 can be analyzed, for example in a laboratory environment, to obtain information (e.g., relative permeability) about the formation. This information can then be used during operations to extract the desirable fluid from the formation. An example permeable rock core is shown in FIG. 1B. The core 100 defines an entry end 100A and an exit end 100B. Although the core 100 is vertically oriented in the examples, this disclosure contemplates that the core 100 (or portions thereof) can optionally be oriented horizontally and/or at angles between horizontal and vertical.

The system can include at least one pressure source 110 configured to inject a fluid into the core 100. In some implementations, the injected fluid (e.g., sometimes referred to herein as a “first fluid”) is gas. When the injected fluid is gas, the pressure source 110 can optionally include a pressurized reservoir and a gas pressure regulator, for example. An example pressurized cylinder (e.g., reservoir) with a gas pressure regulator is shown in FIG. 1C. The gas pressure regulator reduces the pressure of the gas in the pressurized reservoir to the desired pressure level. For example, the pressure source 110 can be configured to inject the first fluid into the core 100 at a pressure greater than an entry capillary pressure of the core 100. As shown in FIGS. 1A and 1D, the first fluid can be injected into the entry end 100A of the core 100 using the pressure source 110. Additionally, in some implementations, liquid (e.g., water) is optionally injected into the core 100. Optionally, the liquid can be injected into the entry end 100A of the core 100. When the injected fluid is liquid, the system can include a second pressure source such as pump, for example. The pump can be configured to inject the liquid into the core 100 at the desired pressure level.

The system can also include a nondestructive test (NDT) device 120 configured to measure a saturation profile of a fluid (e.g., sometimes referred to herein as a “second fluid”) along the core 100. The saturation profile can optionally be measured at each of a plurality of times. Additionally, as described above, the NDT device 120 can measure the respective saturation profile of a plurality of fluids along the core 100. In some implementations, the saturation profile is measured along an entire length of the core 100, e.g., from the entry end 100A to the exit end 100B. Alternatively, in some implementations, the saturation profile is measured along a portion of the core 100. For example, as shown by the dotted arrows in FIG. 1A, the core 100 can be configured to move relative to the NDT device 120. For example, as shown in FIG. 1D, the core 100 can be arranged in a positioning system 105 that is configured to move relative to the NDT device 120 (e.g., up and down in FIG. 1D). In other words, the positioning system 105 is configured to move up and down such that the core 100 can be imaged by the NDT device 120. In some implementations, the NDT device 120 is a CT imaging device. Although a CT imaging device is provided as an example herein, it should be understood that the NDT device 120 can be any device configured to measure saturation profiles along the core 100, including but not limited to, devices using gamma ray, neutron probes, and/or other electrical measurement technologies.

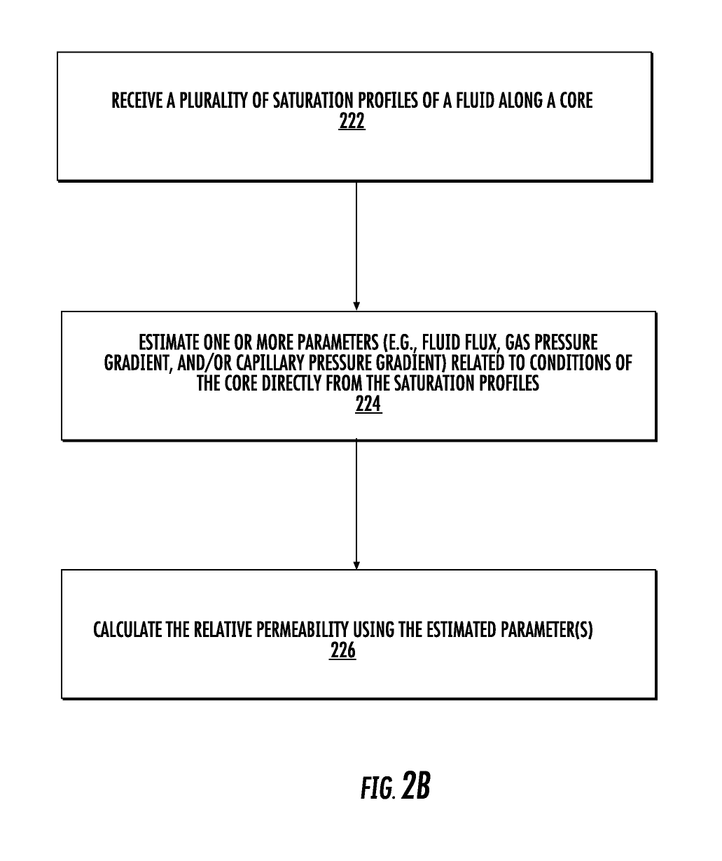

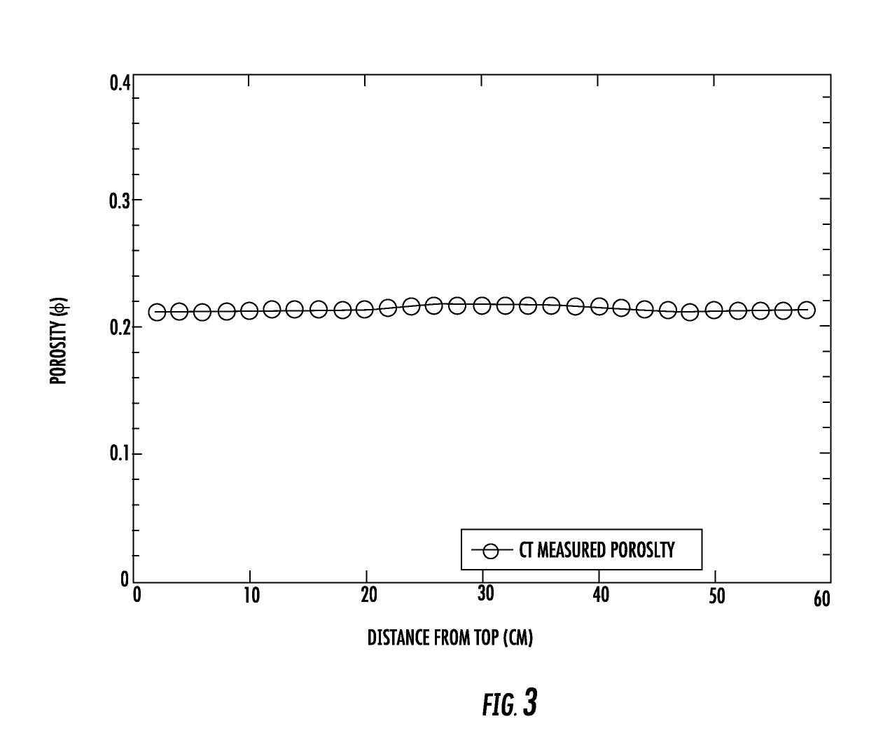

The system can also include a computing device 130. Optionally, the computing device 130 can include one or more of the components of the example computing device of FIG. 2A (e.g., a processor and a memory operatively coupled to the processor). As shown in FIG. 1A, the NDT device 120 and the computing device 130 can be communicatively connected via a communication link. This disclosure contemplates a communication link is any suitable communication link. For example, a communication link may be implemented by any medium that facilitates data exchange between the network elements including, but not limited to, wired, wireless and optical links. Example communication links include, but are not limited to, a LAN, a WAN, a MAN, Ethernet, the Internet, or any other wired or wireless link such as WiFi, WiMax, 3G or 4G. Alternatively or additionally, the NDT device 120 and the computing device 130 can be communicatively connected via a network. The NDT device 120 and the computing device 130 can be coupled to the network through one or more communication links. This disclosure contemplates that the network is any suitable communication network. The network can include a local area network (LAN), a wireless local area network (WLAN), a wide area network (WAN), a metropolitan area network (MAN), a virtual private network (VPN), etc., including portions or combinations of any of the above networks.

As described below, the computing device 130 can be configured to estimate one or more parameters related to conditions of the core 100 (e.g., at least one of a fluid flux, a gas pressure gradient, or a capillary pressure gradient) directly from the saturation profiles measured by the NDT device 120. Additionally, as described below, the computing device 130 can be configured to calculate the relative permeability using the estimated parameters.

Referring to FIG. 2A, an example computing device 200 upon which embodiments of the invention may be implemented is illustrated. It should be understood that the example computing device 200 is only one example of a suitable computing environment upon which embodiments of the invention may be implemented. Optionally, the computing device 200 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 200 typically includes at least one processing unit 206 and system memory 204. Depending on the exact configuration and type of computing device, system memory 204 may be volatile (such as random access memory (RAM)), non-volatile (such as read-only memory (ROM), flash memory, etc.), or some combination of the two. This most basic configuration is illustrated in FIG. 2A by dashed line 202. The processing unit 206 may be a standard programmable processor that performs arithmetic and logic operations necessary for operation of the computing device 200. The computing device 200 may also include a bus or other communication mechanism for communicating information among various components of the computing device 200.

Computing device 200 may have additional features/functionality. For example, computing device 200 may include additional storage such as removable storage 208 and non-removable storage 210 including, but not limited to, magnetic or optical disks or tapes. Computing device 200 may also contain network connection(s) 216 that allow the device to communicate with other devices. Computing device 200 may also have input device(s) 214 such as a keyboard, mouse, touch screen, etc. Output device(s) 212 such as a display, speakers, printer, etc. may also be included. The additional devices may be connected to the bus in order to facilitate communication of data among the components of the computing device 200. All these devices are well known in the art and need not be discussed at length here.

The processing unit 206 may be configured to execute program code encoded in tangible, computer-readable media. Tangible, computer-readable media refers to any media that is capable of providing data that causes the computing device 200 (i.e., a machine) to operate in a particular fashion. Various computer-readable media may be utilized to provide instructions to the processing unit 206 for execution. Example tangible, computer-readable media may include, but is not limited to, volatile media, non-volatile media, removable media and non-removable media implemented in any method or technology for storage of information such as computer readable instructions, data structures, program modules or other data. System memory 204, removable storage 208, and non-removable storage 210 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 206 may execute program code stored in the system memory 204. For example, the bus may carry data to the system memory 204, from which the processing unit 206 receives and executes instructions. The data received by the system memory 204 may optionally be stored on the removable storage 208 or the non-removable storage 210 before or after execution by the processing unit 206.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

It should be appreciated that the logical operations described herein with respect to the various figures may be implemented (1) as a sequence of computer implemented acts or program modules (i.e., software) running on a computing device (e.g., the computing device described in FIG. 2A), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

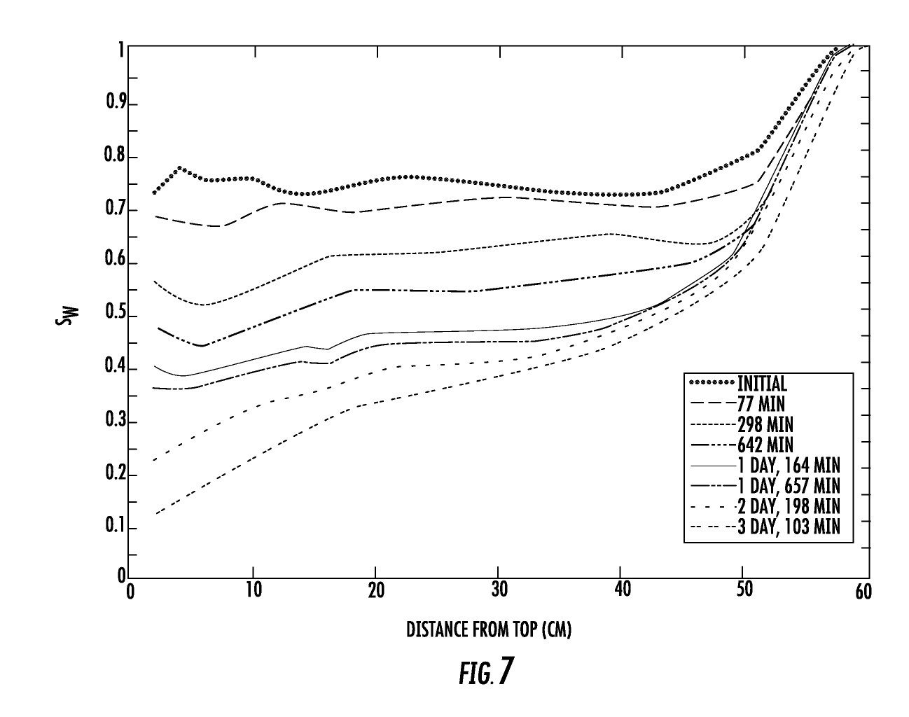

Referring now to FIG. 2B, a flow chart illustrating example operations for obtaining relative permeability from unsteady state saturation profiles is shown. Using the techniques described herein, it is possible to measure relative permeability directly from unsteady state saturation profiles. Additionally, the measured relative permeability can be multi-phase such as two-phase (e.g., gas and water) or three-phase (e.g., gas, oil, and water). Additionally, it should be understood that the techniques described herein are not limited to two-phase and three-phase implementations and can be applied when there are more than three phases (e.g., four-, five-, etc.-phase such as gas, oil, water, and one or more liquid phases). Using a NDT device (e.g., NDT device 120 of FIG. 1A) such as a CT scanner, the saturation profile of a fluid (e.g., water and/or oil) along a core can be measured at each of a plurality of times. This disclosure contemplates that the core can be permeable rock. At 222, a plurality of saturation profiles of the fluid along the core (e.g., as measured by the NDT device) can be received, for example, at a computing device such as the computing device 130 of FIG. 1A. As described herein, the saturation profiles can be measured at each of a plurality of times. At 224, one or more parameters (e.g., fluid flux, gas pressure gradient, and/or capillary pressure gradient) related to conditions of the core can be estimated directly from the saturation profiles received at 222. In particular, the parameter(s) can be estimated from data for a region of the core where the saturation profiles meet predetermined criteria. For example, the parameter(s) can be estimated from the saturation profiles in a region of the core where the saturation profiles are spatially uniform, for example as shown by FIGS. 6-9 in the middle section (˜15 cm to ˜40 cm) of the core. Additionally, the parameter(s) can be estimated from the saturation profiles in a region of the core where saturation gradients are small (e.g., less than a threshold value). The threshold value of the saturation gradient can be calculated from one or more material properties of the core. In other words, the threshold value can vary depending on the properties of the core and/or fluids. For example, the threshold value can optionally be calculated from the capillary pressure curve, the density difference between the fluid, and the gravitational driving force. For example, in the two-phase study examples described below, the threshold value is about 0.1 m⁻¹ for the sandstone rocks used in the studies. In particular, in the two-phase study Tests 2-5, the saturation gradients are relatively small (e.g., less than about 0.1 m⁻¹), while in the two-phase study Test 1, the saturation gradient is relatively large (e.g., about 0.82 m⁻¹). The disclosure contemplates, however, that the threshold value should not be limited to about 0.1 m⁻¹ and instead is related to one or more material properties of the core and/or fluids. As described herein, when the saturation profiles meet these predetermined criteria, it is possible to neglect the capillary pressure gradient. Additionally, instead of neglecting the gas pressure gradient, this term can be estimated from the saturation profiles and used in the relative permeability calculation. As described herein, a fluid (e.g., gas) can be injected into the core (e.g., at the entry end), which is the reason why the gas pressure gradient is not negligible. By injecting gas into the core, it is possible to overcome the entry capillary forces and allow fluid to gravity drain from the exit end of the core. Then, at 226, the relative permeability can be calculated using the parameter(s), for example, using computing device such as the computing device 130 of FIG. 1A.

### Examples

### Determining Relative Permeability from Unsteady State Saturation Profiles in Two-Phase Systems

Techniques for measuring relative permeability of liquids in permeable rock directly from transient in-situ saturation profiles during gravity drainage are described below. Optionally, the relative permeability can be a multi-phase (e.g., a two-phase or three-phase) relative permeability. The techniques are advantageous as compared to conventional measurement techniques in terms of both time/expense as well as accuracy. In the examples described below, relative permeabilities were obtained for a 60-cm long vertical Berea sandstone core during gravity drainage directly from the unsteady-state in-situ saturations along the core measured at different times during gravity drainage experiments using a CT scanner (e.g., a NDT device). Additionally, the examples described below demonstrate that, if certain criteria are met, the capillary pressure of the permeable rock can be neglected when determining relative permeability of the liquids. In the examples described below, a correct gas pressure gradient along the core is used by excluding the pressure drops at the outlet of the core due to capillary discontinuity effects. The techniques described below can be used to obtain relative permeabilities in unsteady-state fashion over a wide range of saturations quickly and accurately without requiring any assumption or interpretations of the measured data. The techniques also enable one to obtain extremely small values of relative permeabilities (10⁻⁴-10⁻⁵) due to the “pulling” effect of gravity.

The techniques described below can be used with permeable rocks as gravity is observed to be an efficient contributor to flow in reservoirs (Hagoort 1980; Naylor et al. 1996; Rezaveisi et al. 2010; Mohsenzadeh et al. 2011). In reservoirs, the fluid column height is large enough to create high driving forces solely due to gravity. To measure such gravity drainage processes in a laboratory environment, long cores are needed so the fluid column pressure exceeds the entry capillary pressure of the core, and the fluids inside the core can flow by gravity. However, it is practically impossible to have such long cores in laboratory. Shorter cores in laboratory on the other hand show no fluid movement due to insufficient fluid column pressures. This is why Sahni and others (Sahni, Burger, and Blunt 1998; DiCarlo, Akshay, and Blunt 2000; H. Dehghanpour et al. 2011; Hassan Dehghanpour et al. 2010; Kianinejad et al. 2014) used only sandpacks for their experiments. Sandpacks have smaller capillary forces, so the fluids can drain by gravity even in shorter columns.

As described below, the gravity drainage method is extended to consolidated media (e.g., permeable rock) by using a small gas pressure gradient to overcome capillary forces. In particular, relative permeabilities in consolidated rocks in unsteady-state gravity driven experiments are obtained, directly from the measured in-situ saturations along the core samples. Two-phase (e.g., gas and liquid phases) water relative permeability in a 60-cm long Berea sandstone core are obtained. A first fluid (e.g., a gas) is injected as at pressures above the entry capillary pressure of the rock, so the gas phase can invade the core and fluids can flow vertically by gravity. Although gas is injected from the entry of the core (e.g., the top), the drainage process is still gravity dominated process and the injected gas allows the in-situ fluids (water/oil) drain by gravity. In addition, gas injection allows to access relative permeabilities at higher saturations.

Using the techniques described herein, relative permeabilities can be obtained directly from saturation profiles, which removes the need of assumptions and interpretations (e.g., as required by the Johnson, Bossier, and Naumann (JBN) method) to calculate relative permeabilities through unsteady-state measurements. In addition, by using the middle-section saturation data along the 60-cm Berea core, capillary discontinuity effects at the entry end and the exit end of the core are avoided. Moreover, the gravity drainage method achieves low fluid saturations and very small relative permeability values (10⁻³-10⁻⁴) due to “pulling” effect of gravity as opposed to “pushing” effect occurring during flooding experiments.

### Theory and Formulation

It should be understood that it is possible to combine measured saturation vs. space and time with the Darcy-Buckingham equation and material balance equation to obtain relative permeabilities in vertical sandpacks. As described below, it is possible to extend this theory to consolidated media (e.g., permeable rock).

The Darcy-Buckingham equation gives:

$${u}_{i} = \frac{{kk}_{ri}}{{μ}_{i}} \frac{d {Φ}_{i}}{dz} \qquad ( 1 )$$

where μ is fluid flux, k is permeability, kᵣ is relative permeability, μ is viscosity, Φ is fluid potential, and z is position along the core. Subscript i denotes phase. The fluid potential can be extended as:

Φᵢ=Pᵢ+ρᵢgZ (2)

where P is pressure, ρ is density, and g is gravity. Extending the above equation one further step using the definition of capillary pressure gives:

Φᵢ=P_{g}−P_{c}_{_{gi}}+ρᵢgz (3)

where P_{c} is capillary pressure, P_{c}=P_{g}−Pᵢ.

Consequently, Eq. 1 can be rearranged to obtain relative permeability at each time and position along the core as:

$${k}_{ri} ( z , t ) = \frac{{u}_{i} ( z , t ) {μ}_{i}}{k ( \frac{{dP}_{g} ( z , t )}{dz} + {ρ}_{i} g - \frac{{dP}_{c} ( z , t )}{dz} )} \qquad ( 4 )$$

To calculate relative permeability using Eq. 4, all of the terms on the right hand side of Eq. (4) need to be measured. It should be understood that the core's absolute permeability, as well as fluid density and viscosity, can be measured using techniques known in the art. Accordingly, the unknown parameters (also referred to herein as the “one or more parameters” or “parameters”) that need to be measured (or neglected) during the experiments are fluid flux (uᵢ(z,t)), gas pressure gradient

$$( \frac{{dP}_{g} ( z , t )}{dz} ) ,$$

and capillary pressure gradient

$$( \frac{{dP}_{c} ( z , t )}{dz} )$$

as a function of space and time. In other words, one or more parameters related to conditions of the core can be estimated directly from the measured saturation profiles as described below.
Estimating Fluid Flux from the Measured Saturation Profiles

Measuring the in-situ fluid saturation profiles along the core at different times during the experiment as Sᵢ(z,t), it can be shown that the fluid flux at each time and position along the core can be obtained at discrete points from:

$${u}_{i} ( {z}^{*} , {t}_{j + 1 / 2} ) = \frac{{\int }_{z = 0}^{{z}^{*}} ( [ {S}_{i} ( z , {t}_{j + 1} ) - {S}_{i} ( z , {t}_{j} ) ] φ d z )}{{t}_{j + 1} - {t}_{j}} \qquad ( 5 )$$

where S is fluid saturation, φ is porosity, and t is time. In Eq. (5), subscript j denotes time step. Hence, the amount of fluid (uᵢ(z,t)) passing through each cross section of the core during a specific time interval at discrete points can be obtained from the measured saturation profiles.
Estimating Gas Pressure Gradient from the Measured Saturation Profiles

In previous relative permeability measurements in sandpacks, the pressure gradient for the gas phase was assumed to be negligible compared to the gravitational gradient, because μ_{G}<<μ_{L} and gas was not forced. μ_{G} is the gas viscosity and μ_{L} is the liquid viscosity. This is a common assumption for flow in soils or sandpacks, as is shown in the Richards' equation (Richards 1931) for water movement in soils. Accordingly, the gas pressure gradient term,

$$( \frac{{dP}_{g} ( z , t )}{dz} ) ,$$

was ignored and relative permeabilities were obtained within a few percent error (Sahni, Burger, and Blunt 1998; DiCarlo, Akshay, and Blunt 2000; H. Dehghanpour et al. 2011; Kianinejad et al. 2014). However, in the examples below, since the entry capillary pressure is significantly higher than 60 cm of water column, a first fluid (e.g., gas) is injected at pressures higher than entry capillary pressure to allow fluids flow by gravity in the core. Therefore, the injection gas pressure gradient is comparable or greater than the gravitational gradient, and the gas pressure gradient is estimated (described below) and not neglected when determining relative permeabilities according to the techniques described herein.
Estimating Capillary Pressure Gradient from the Measured Saturation Profiles

In Eq. (4), the capillary pressure gradient

$$( \frac{d {P}_{c} ( z , t )}{d z} )$$

and the gas pressure gradient

$$( \frac{d {P}_{g} ( z , t )}{d z} )$$

are both added to gravitational gradient, ρᵢg. Thus, if the sum of the capillary pressure gradient and the gas pressure gradient are much less than the gravitational gradient, these terms can be neglected when calculating the relative permeabilities. It has been shown that, depending on certain criteria, the capillary pressure gradient can be much less than the gravitational gradient. In particular, the criteria where this assumption is valid are:
Far behind (e.g., >15 cm) the moving shock front, where the saturation profile is spatially flat and uniform; and
Far from entry and exit of the core (>15 cm from the entry end of the 60 cm core), where the capillary entry and end effects do not exist.

These criteria are based on the fact that capillary pressure gradient can be extended as:

$$\frac{d {P}_{c} ( z , t )}{d z} = \frac{d {P}_{c}}{d S} \frac{\partial S ( z , t )}{\partial z} \qquad ( 6 )$$

Hence, if the saturation gradient

$$( \frac{\partial S ( z , t )}{\partial z} )$$

is small enough (e.g., less than a threshold value) such that the capillary pressure gradient is smaller than the other gradients

$$( \frac{d {P}_{c} ( z , t )}{d z} ≪ {ρ}_{i} g + \frac{d {P}_{g} ( z , t )}{d z} ) ,$$

then the capillary pressure gradient term can be neglected. In other words, under certain conditions, it is possible to neglect the capillary pressure gradient when calculating the relative permeability. For example, the capillary pressure gradient can be neglected when it is less than a sum of a gas pressure gradient and a gravitational gradient. Optionally, the capillary pressure gradient can be neglected when a ratio of the capillary pressure gradient to the sum of the gas pressure gradient and the gravitational gradient is less than about 0.2.

Once all the required information are obtained from the measured saturation profiles, relative permeabilities at discrete points can be calculated using Eq. (4) at the sections of the core where both of the above mentioned criteria are met. In other words, the other parameters related to conditions of the core (e.g., fluid flux and/or gas pressure gradient) can be estimated for a region of the core where the saturation profiles meet predetermined criteria—(i) the saturation profiles are spatially uniform and (ii) the saturation gradients are less than a threshold value.

### Two-Phase Relative Permeability Examples

### Permeable Rock Sample

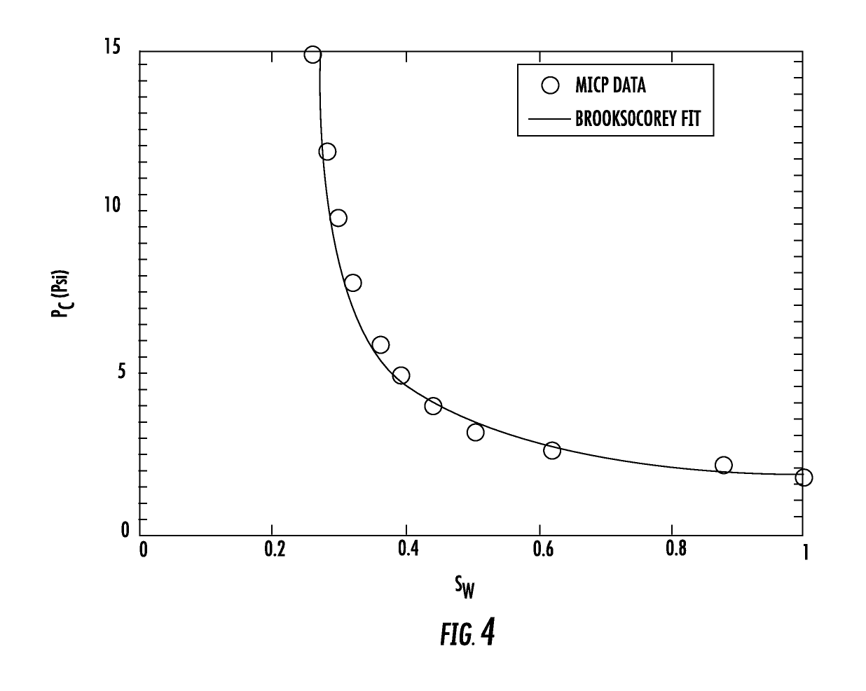

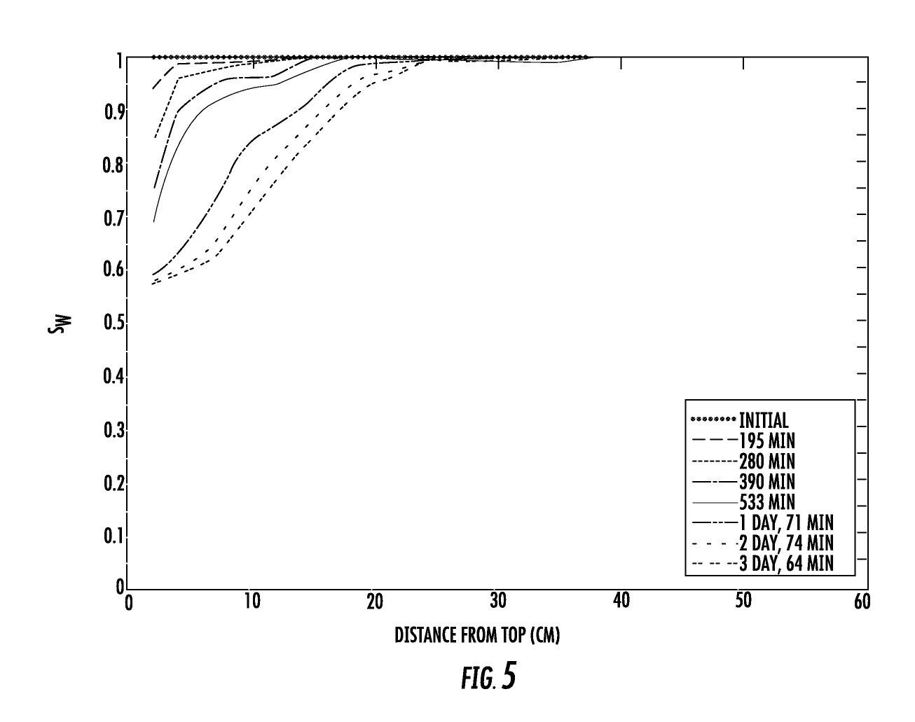

A single Berea sandstone core was used in the examples described below. The Berea core was 2-ft long and 3-inch in diameter with an average porosity of 0.215 measured by CT scanning (e.g., NDT device). FIG. 3 is a graph illustrating the CT measured porosity along the example core. The permeability of the Berea sandstone sample used in the experiments was measured as 300 md, from a separate core sample cut from the same Berea block with 9.5-inch long and 1.5-inch diameter. Capillary pressure of the rock sample was also measured using mercury intrusion capillary pressure (MICP) method. FIG. 4 is a graph that shows the measured capillary pressure curve and its Brooks-Corey fit to the experimental data after converting the raw data to the water-gas system using corrections explained in (Pini and Benson 2013). The Brooks-Corey model (Brooks and Corey 1964):

$${P}_{{c}_{gw}} = {{P}_{{c}_{entry}} ( \frac{1 - {S}_{wr}}{{S}_{w} - {S}_{wr}} )}^{1 / λ} \qquad ( 7 )$$

uses P_{c}_{_{entry}}=2 psi(13.8 kPa), S_{wr}=0.25, and λ=1.66 to fit the experimental data shown in FIG. 4.

### Fluids

A light brine (1 wt % sodium bromide aqueous solution) was used for all two-phase water/gas experiments as the aqueous phase, while air was used as the gas phase. The physical properties of the fluids are summarized in Table I below.

TABLE I
Physical properties of the fluids used in the experiments

| Fluid | Density (kg/m³) | Viscosity (cp) |
|---|---|---|
| Light brine (1 wt % NaBr) | 1006 | 1.02 |
| Air | 1.2 | 0.02 |

### Methods

### Fluid Calibrations

To calculate fluid saturations during the experiments, calibrations at one energy level were required. The calibrations for gas and brine saturated core were obtained once the core was completely dry (100% gas saturated), and once when the core was completely saturated with brine at 100 kV energy level.

### Saturation Profile Measurements

Using a vertical positioning system, the core was moved vertically and scanned using the CT scanner at different positions with 2-cm intervals from top to the bottom. Since the experiments were two-phase, the core was scanned at only one energy level to measure the in-situ saturations along the core during the experiments. Combining the measured CT values with the fact that summation of water and gas saturations equals to one, fluid saturations were calculated along the core at different times, Sᵢ(z,t).

### Experiment Procedures

As described below, five (5) two-phase, water/gas gravity drainage experiments (also referred to herein as two-phase study Tests 1-5) were conducted on a single Berea core sample. During all the experiments, the core was vertically oriented and simultaneously scanned at 2 cm intervals using a CT scanner to measure the in-situ saturations along the core at different times. In other words, at each of a plurality of times, a respective saturation profile of a fluid along the core was measured. Additionally, a fluid (e.g., gas) was injected from the top (e.g., at the entry end) of the core at a specific pressure for each experiment, while the bottom of the core was open to the atmosphere to permit gravity draining during all the experiments. The injecting gas was first bubbled through a column of water before entering the core to equilibrate the gas with water vapor and avoid any saturation changes due to evaporation of fluids inside the core.

To prepare the core for the first experiment, two-phase study Test 1, the core was vacuumed from the top for several hours, and then was completely saturated with brine injecting from the bottom. Test 1 was then started by injecting gas from the top of the core at 1.2 psig (8.27 kPa) with the bottom of the core open to the atmosphere to drain by gravity. To initialize the core for the second experiment, two-phase study Test 2, the water remaining in the core at the end of Test 1 was driven down to the bottom 10 cm of the core by increasing the pressure of the injecting gas to 1.65 psig (11.37 kPa). Afterwards, Test 2 was started by injecting gas from the top at 3.78 psig (26.06 kPa) while the bottom of the core was open to the atmosphere. To prepare the core for two-phase study Tests 3 and 4, the core was flooded with brine from the bottom after their respective previous experiments without applying vacuum, resulting in the core saturated with water and residual gas. Test 3 and 4 then were conducted under gas injecting from the top at pressures of 6.13 and 8.96 psig (42.26 and 61.77 kPa), respectively. The core was prepared for the last experiment, two-phase study Test 5, by vacuuming from the top for several hours and then injecting brine from the bottom to make the core 100% saturated with water. Test 5 was conducted under gas injection at the same pressure as that of Test 4, 8.96 psig (61.77 kPa). The initial and operating conditions of the experiments are listed in Table II.

TABLE II
Two-phase experiments with different
initial and conducting conditions

| Test | Type of drainage | Gas injection pressure (psig) |
|---|---|---|
| 1 | Primary | 1.2 |
| 2 | Secondary | 3.78 |
| 3 | Secondary | 6.13 |
| 4 | Secondary | 8.96 |
| 5 | Primary | 8.96 |

### Results

Saturation Vs. Space and Time

Results of the two-phase, gas/water experiments in the consolidated core are presented below. Additionally, the results demonstrate how and when the techniques for relative permeability measurements from unsteady state saturation profiles described herein can be used.

In contrast to previous drainage studies with sandpack columns, opening a vertical 60-cm long water saturated Berea core to the atmosphere does not cause any fluid movement inside the core. In order for gas to invade the Berea sample, the core must be longer than at least 140 cm since the gas entry pressure of the core is 2 psi (13.8 kPa) (see FIG. 4). However, as noted above, it is difficult to have such a long core in a laboratory. Accordingly, a fluid (e.g., gas) is injected from the top of the core to compensate for this insufficiency of the length of the core. The fluid is injected at a pressure greater than an entry capillary pressure of the core.

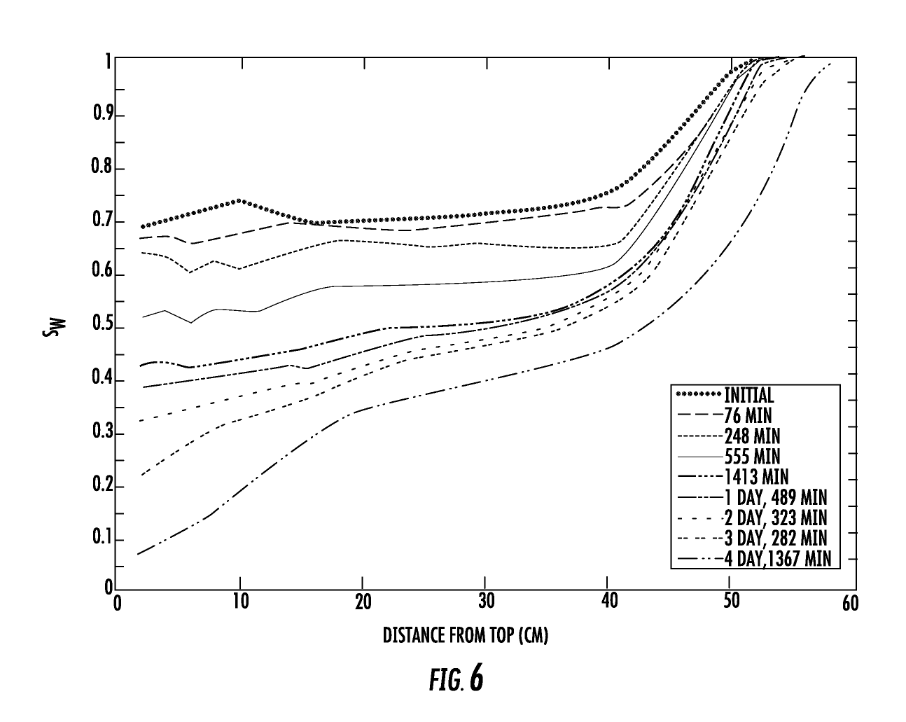

FIG. 5 is a graph that shows the water saturation profile along the core during the primary drainage (S_{wi}=1) experiment (two-phase study Test 1) of fully water saturated core while gas is being injected at 1.2 psig (8.27 kPa) from the top of the core. It can be observed that at this gas pressure (1.2 psig), water does drain out of the core, as compared to the case when no extra pressure where the water remains held due to capillary pressure. But at P_{g}=1.2 psig, the water front stops at z=25 cm, with the water below this still being held by capillary forces. In addition, in this region the saturation gradients in the drained section are relatively large, e.g., saturation gradient of

$$\frac{d {S}_{w}}{d z} \geq 0.82 {m}^{- 1} .$$

Using the capillary pressure function of the rock sample (Eq. (7)) along with the saturation gradients mentioned for the drained section of the core results in the capillary pressure gradient of

$$\vert \frac{d {P}_{c}}{d z} \vert \geq 13.47 \frac{psi}{m} .$$

These values indicate that the capillary pressure gradients in this section of the core are greater than the pressure of injecting gas and gravitational gradient

$$( {ρ}_{w} g = 1.43 \frac{psi}{m} ) .$$

### Therefore, the

$$\frac{d {P}_{c}}{d z}$$

term in Eq. 4 is not negligible. Consequently, the saturation profiles for two-phase study Test 1 do not meet the predetermined criteria described above (e.g., (i) the saturation profiles are spatially uniform and (ii) the saturation gradients are less than a threshold value) to be used for relative permeability calculations using the techniques described herein.

In the next 4 experiments, each drainage used a higher gas injection pressure. The goal was to move the water front further down and see how the injection pressure affects the saturation profiles in (a) providing more spatial room for saturations to change along the core, and (b) obtaining spatially uniform saturation regions which meet the capillary criteria for calculating relative permeabilities.

FIG. 6 is a graph that shows the secondary water/gas drainage experiment (two-phase study Test 2) with gas being injected at 3.78 psig (26.06 kPa). Comparing FIG. 6 with FIG. 5 shows that injecting gas at 3.78 psig drives the water front all the way down to the bottom of the core, while the capillary end effect reduces to bottom 20 cm of the core. Most importantly, the water saturation profiles shown in FIG. 6 have a much smaller saturation gradient in the top 40-cm of the core. In other words, the saturation profiles in this region of the core are less than a threshold value. As mentioned above, the top 15 cm of the core is affected by the capillary entry effect; in addition, the bottom 20 cm is affected by the capillary end effect. Importantly, as shown in FIG. 6, the middle 25 cm section (e.g., from ˜15 cm to 40 cm) of the core meets the criteria mentioned above for relative permeability calculations. In particular, the saturation profiles in this region are spatially uniform and have small saturation gradients that result in a negligible capillary pressure gradient. For example, the saturation profile corresponding to t=76 min (the second curve from the top) shown in FIG. 6 has a saturation gradient of

$$\vert \frac{d {S}_{w}}{d z} \vert \leq 0.12 {m}^{- 1}$$

in the middle 25 cm of the core, far from the entrance and exit of the core. In this section of the core,

$$\frac{d {P}_{c}}{d S} \approx - 3.34 psi ,$$

calculated from the measured capillary pressure curve for the rock sample (see FIG. 4). Consequently,

$$\vert \frac{d {P}_{c}}{d z} \vert \leq 0.4 \frac{psi}{m} .$$

As described below, a method for estimating the gas pressure gradient in the middle region of the core for each experiment from numerical simulations is provided. Here, for the purpose of calculations, the gas pressure gradients estimated as described below are used to show the significance of capillary pressure gradient compared to the other gradients. The numerical simulations estimate that, in two-phase study Test 2, the gas pressure gradient in the middle of the core is

$$\frac{d {P}_{g}}{d z} = 2.133 \frac{psi}{m} ,$$

while the gravitational gradient is

$${ρ}_{w} g = 1.43 \frac{psi}{m} .$$

Therefore, the capillary pressure gradient for this particular saturation profile is less than the sum of the gas pressure gradient and gravitational gradient, and the ratio of the capillary pressure gradient to the sum of the gas pressure gradient and gravitational gradient is

$$\frac{{dP}_{c} / dz}{{dP}_{g} / dz + {ρ}_{w} g} \leq 0.11 .$$

This confirms that the capillary pressure gradient for this section is small compared to gas pressure gradient and gravitational gradient, and neglecting the capillary gradient in the relative permeability calculation results in a bias of 11% or less.

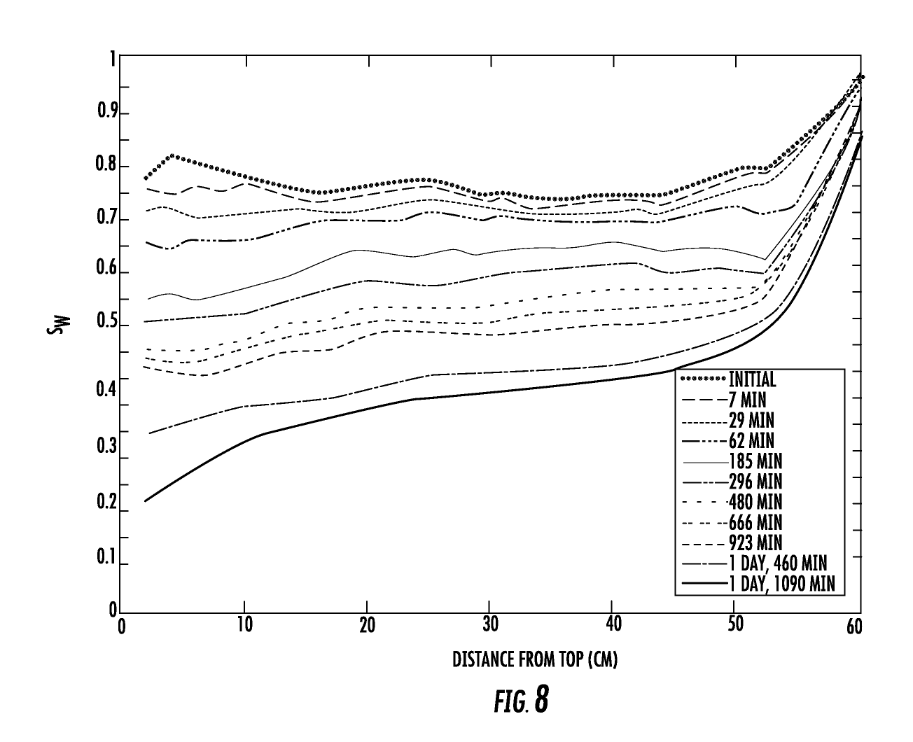

FIG. 7 is a graph that shows the saturation profile during two-phase study Test 3 where the gas is injected at 6.13 psig. Comparing FIGS. 6 and 7 indicates that injecting gas at higher pressure results in a smaller capillary end effect (bottom 15 cm), and consequently, a longer region with low saturation gradients along the core. Therefore, more saturation data are available for relative permeability calculations (e.g., from ˜10 cm to ˜45 cm). In FIG. 7, the capillary end effect decreases to the bottom 15 cm of the core, while this value was 20 cm for the two-phase study Test 2 (see FIG. 6). Like Test 2, in two-phase study Test 3 the middle 25 cm section of the core is used for estimating the parameters related to conditions of the core, far from capillary entry and end effect for relative permeability calculations. As it can be seen in FIG. 7, the saturation profiles in this section are spatially uniform with small saturation gradients (e.g., less than a threshold value) which meet the predetermined criteria for neglecting capillary pressure gradient. For instance, consider the saturation profile corresponding to t=298 min in FIG. 7 (the third curve from the top). For this saturation profile, the saturation gradient is

$$\vert \frac{{dS}_{w}}{dz} \vert \leq 0.12 {m}^{- 1}$$

while

$$\frac{{dP}_{c}}{dS} \approx - 4.45 psi .$$

### Consequently,

$$\vert \frac{{dP}_{c}}{dz} \vert \leq 0.55 \frac{psi}{m} .$$

### Having

$$\frac{{dP}_{g}}{dz} = 5.15 \frac{psi}{m}$$

for this experiment from simulation results and the above mentioned gravitational gradient results in

$$\frac{{dP}_{c} / dz}{{dP}_{g} / dz + {ρ}_{w} g} \leq 0.084 .$$

Therefore, calculated relative permeabilities from this saturation profile are biased less than 8.4% when ignoring the capillary pressure.

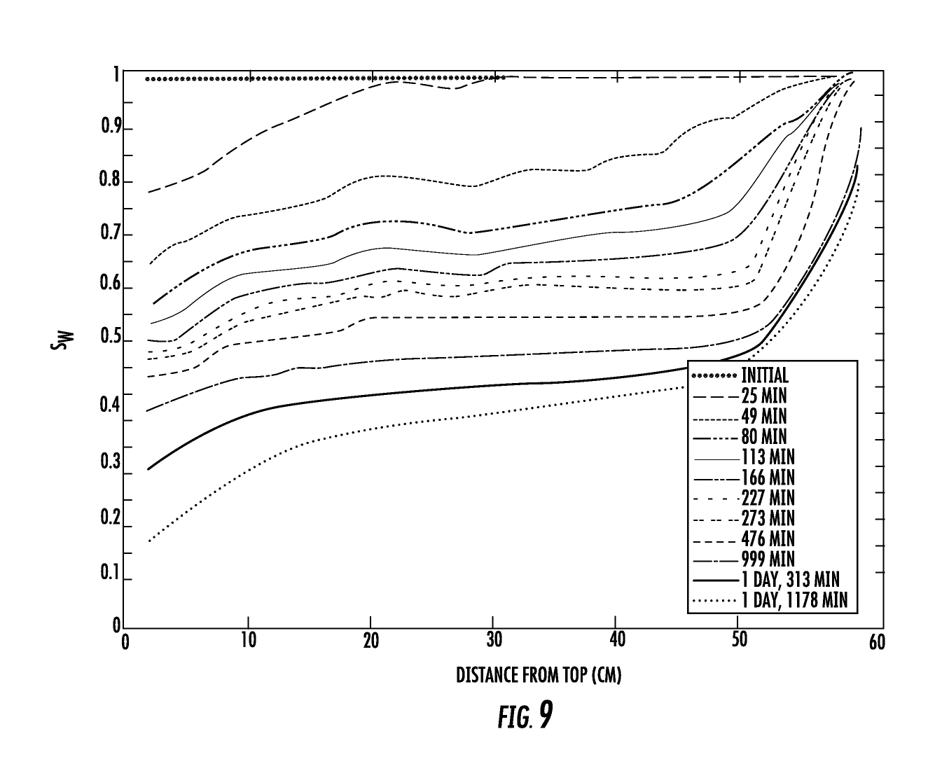

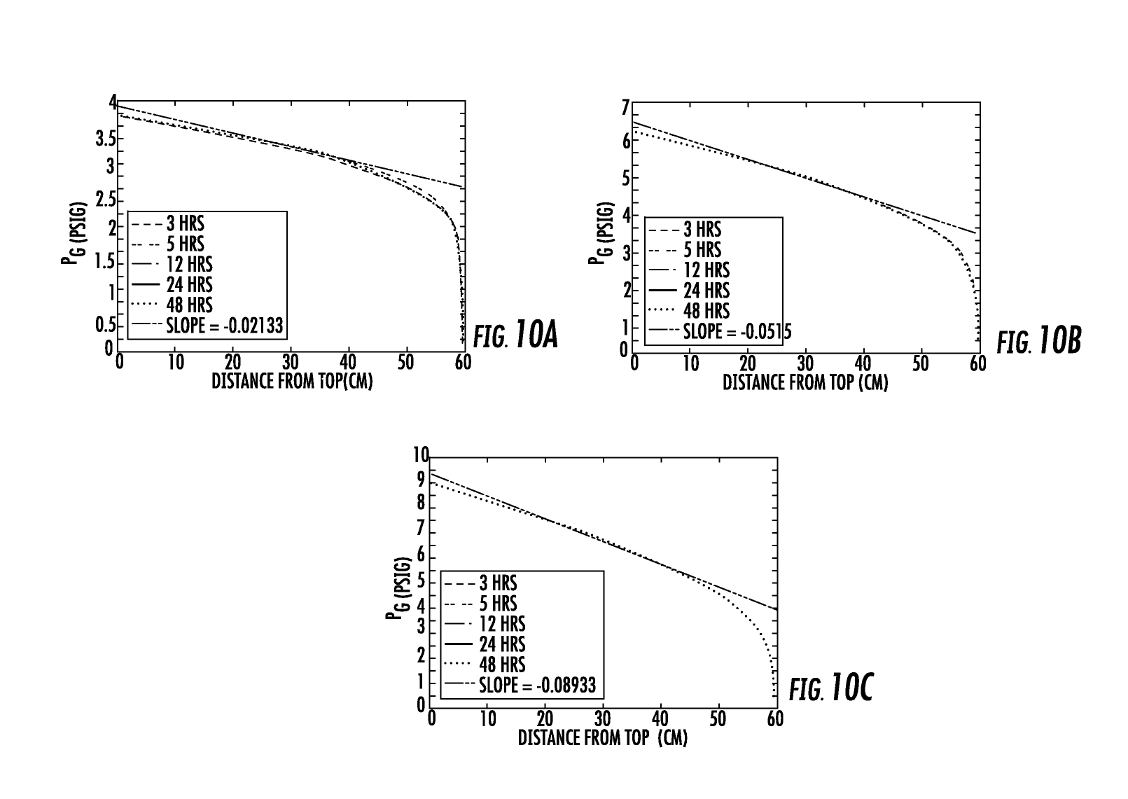

FIG. 8 is a graph that shows the saturation profile during two-phase study Test 4 where the gas is injected at 8.96 psig. FIG. 9 is a graph that shows the saturation profile during two-phase study Test 5 where the gas is injected at 8.96 psig. As shown in these figures, the capillary end effect is pushed even further down to the bottom 10 cm of the core. This smaller capillary end effect provides more space for uniform saturation changes which consequently provides larger space for relative permeability calculations discussed in the following. To show these saturation profiles also meet the criteria for relative permeability calculations, consider the fourth curve from the top of FIG. 8 corresponding to t=62 min for instance. In this saturation profile, the saturation gradient is

$$\vert \frac{{dS}_{w}}{dz} \vert \leq 0.02 {m}^{- 1}$$

while its corresponding

$$\frac{{dP}_{c}}{dS} \approx - 3.27 psi ;$$

which results in

$$\vert \frac{{dP}_{c}}{dz} \vert \leq 0.065 \frac{psi}{m} .$$

Since we have

$$\frac{{dP}_{g}}{dz} = 8.933 \frac{psi}{m}$$

for this experiment from the simulation results and

$${ρ}_{w} g = 1.43 \frac{psi}{m} ,$$

the ratio of the capillary pressure gradient to the sum of the gas pressure and gravitational gradients results

$$\frac{{dP}_{c} / dz}{{dP}_{g} / dz + {ρ}_{w} g} \leq 0.006 .$$

Therefore, this saturation profile meets the predetermined criteria and neglecting the capillary pressure gradient term results in relative permeabilities with only less than 0.6% bias. The same reason applies to the saturation profiles shown in FIG. 9 for the middle section saturation data, and confirms that the predetermined criteria are met for relative permeability calculations.

### Gas Pressure Gradient

As noted above, previous studies used gravity drainage methods to measure relative permeabilities in unconsolidated sandpacks (Sahni, Burger, and Blunt 1998; DiCarlo, Akshay, and Blunt 2000; Dicarlo, Sahni, and Blunt 2000; Hassan Dehghanpour and DiCarlo 2013; H. Dehghanpour and DiCarlo 2013; Kianinejad et al. 2014), but the methods neglected the gas pressure gradient term,

$$\frac{{dP}_{g} ( z , t )}{dz} ,$$

since the pressure gradient of the gas phase was zero, or considerably smaller compared to fluid gravity, ρᵢg. However, due to higher gas entry pressure of the Berea rock (e.g., permeable rock) compared to sandpacks, gas (e.g., a fluid) is injected into the core to allow fluids drain by gravity in the core in the techniques described herein. Thus, the injection gas pressures in the examples provided herein are significant compared to fluid gravitational gradient and cannot be neglected. In the examples,

$${ρ}_{w} g = 1.43 \frac{psi}{m}$$

while injection gas pressures in the 0.6 m long core during two-phase study Tests 2-4 are 3.78, 6.13, and 8.96 psig, respectively.

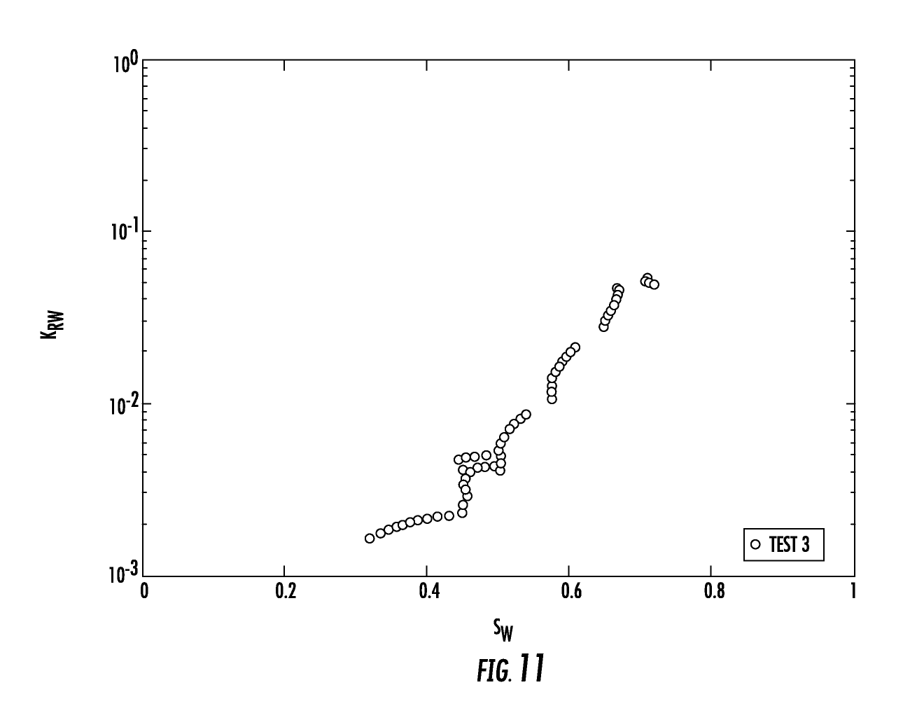

It is well known that due to capillary discontinuity at the outlet of the core, there will be wetting phase hold up and large saturation gradients at the outlet, regardless of the measurement method (Osoba et al. 1951; Richardson et al. 1952; Rapoport and Leas 1953). This behavior is seen in many studies including two-phase study Tests 2-5 described above (see FIGS. 6-9). Due to this capillary hold up at the outlet, a large part of the pressure drop during core floods occurs in the last few centimeters of the core. In particular, there exists a water hold-up region in the bottom 10-20 cm of the core due to capillary end effect (capillary discontinuity). To estimate the pressure drop in this end region and use the correct value of pressure gradient in the middle 20 cm of the core, numerical simulations were using a simulator to obtain the correct gas pressure gradient in the middle section of the core. FIGS. FIGS. 10A-10C are graphs that show the gas pressure along the core at different times for gas injection pressures of 3.78, 6.13, and 8.96 psig, the same values as that of two-phase study Tests 2-5, respectively. FIGS. 10A-10C shows that, after the passage of the gas front to the bottom, the gas pressure gradient at each position along the core is almost constant during the entire experiment. It is evident in FIGS. 10A-10C that there is a sharp pressure drop at the bottom of the core, which is due to capillary end effect mentioned above. To obtain the water relative permeabilities for two-phase study Tests 2-5, the gas pressure gradient associated with the middle 20 cm of the core for each experiment is estimated. In this region of the core, the saturation profiles meet the predetermined criteria—(i) spatial uniformity and (ii) saturation gradients less than a threshold value (e.g., relatively small)—as shown in FIGS. 6-9 and described above. The dashed lines in FIGS. 10A-10C show the slope of the gas pressure profile for each experiment at the middle of the core. The gas pressure gradients shown in FIGS. 10A-10C are

$$\frac{{dP}_{g}}{dz} = 2.133 ,$$

5.15, and 8.933

$$\frac{psi}{m} ,$$

corresponding to two-phase study Tests 2-5, respectively. These values are significantly smaller than the overall pressure gradients of respectively

$$\frac{Δ {P}_{total}}{L} = 6.28 ,$$

10.2, 14.9

$$\frac{psi}{m} ,$$

a good portion of the overall pressure drop is taken up in the end effect.

Therefore, the obtained relative permeabilities will be affected significantly if the gas pressure drop across the core is used in the calculations. Based on the numerical simulation results, the gas pressure gradient at the middle of the core follows the following relationship from physical measurements

$$\frac{d {P}_{g}}{d z} = \frac{Δ {P}_{Total} - 0.68 {P}_{{c}_{entry}} Δ {P}_{Total}^{0.45}}{L} .$$

To determine gas pressure gradient in the middle of the core, a wide range of water and gas relative permeability curves are used to examine the sensitivity of the gas pressure gradient on the input relative permeabilities. For example, it is possible to use the gas relative permeability from k_{rg}=0.1×S_{g}² to k_{rg}=S_{g}², and k_{rg}=0.1×S_{g}³ to k_{rg}=S_{g}³; and water relative permeability from k_{rw}=0.1×S_{w}³ to k_{rw}=S_{w}⁶. The results shows that, although the flow rates of the phases, strongly depend on the input relative permeability curves, the gas pressure along the core does not change significantly with different input water and gas relative permeabilities after the passage of gas front to the bottom due to its low viscosity. Based on the results, the gas pressure gradient changes less than 0.35%, 1.53%, and 2.5% for injection pressures of 3.78, 6.13, and 8.96 psig for two-phase study Tests 2-5, respectively, for the given range of relative permeabilities. These changes in pressure gradients translate into less than 0.25%, 1.2%, and 2.1% change in calculated relative permeabilities, respectively. These small changes confirm the robustness of the used gas pressure gradients for relative permeability calculations.

Therefore, the gas pressure gradient can be estimated by:
Choosing a region from capillary criteria where

$$\frac{d Pc}{d z} ≪ pg$$

Estimating gas pressure gradient from actual pressure and capillary end effect

### Water Relative Permeability

Previous studies have shown that the saturation data at the middle section of a core extending through sandpack, e.g., far from the saturation front, meets the predetermined criteria for relative permeability calculations described herein. In this region, the saturation gradient

$$( \frac{d {S}_{i}}{d z} )$$

tends to be small, and then capillary pressure gradient

$$( \frac{d {P}_{c}}{d z} )$$

is negligible. Although the capillary pressure of the permeable rock described herein is significantly larger than that of the sandpack, as described above, this assumption is still valid for the middle section of a core extending through permeable rock (e.g., middle 20-cm of the example core), after the passage of the frontal shock where the saturation profiles are spatially uniform.

Accordingly, the saturation data from the middle 20 cm section of the core is to calculate the relative permeabilities of water during the two-phase experiments, two-phase study Tests 2-5, shown in FIGS. 6-9. In this section of the core, the measured saturation profiles are spatially uniform with small gradients (e.g., less than a threshold value); and are far from the entry end and exit end of the core, so the entry and end capillary effects are avoided. To obtain relative permeability from each of two-phase study Tests 2-5, the gas pressure gradients of 2.133, 5.15, 8.933, and 8.933

$$\frac{psi}{m}$$

for two-phase study Tests 2-5, respectively, can be estimated from the measured saturation profiles as described above. The estimated gas pressure gradients are estimated from the saturation profiles in the middle section of the core for each experiment. In addition, the gravitational gradient in all the calculations was considered as ρ_{w}g=1.43

$$\frac{psi}{m} .$$

Further, the capillary pressure gradient,

$$( \frac{d {P}_{c}}{d z} ) ,$$

can be neglected since it is negligible compared to the gas pressure and gravitational gradients, as discussed above.

Before presenting the obtained relative permeability curves from two-phase study Tests 2-5, a general overview of the relative permeability data obtained from each pair of saturation profiles according to the techniques described herein is provided. The relative permeability data obtained from each pair of saturation profiles represent a “Γ” shape (also referred to herein as a gamma shape) structure on k_{rw} vs. S_{w} plot. In this structure, the upper right data (horizontal part) represent the data at the lower part of the core which are affected by capillary end effect, while the bottom left relative permeability data (vertical part) are the data corresponding to the upper section of the core which are affected by the capillary entrance effects. Therefore, ideally the middle section saturation data form the “curvature” section, the transition from vertical to horizontal section of relative permeability data, meaning they are not affected by any entrance or exit effects. In other words, depending on the capillarity effects and saturation gradients, the length of the horizontal and vertical part in the obtained relative permeability data varies.

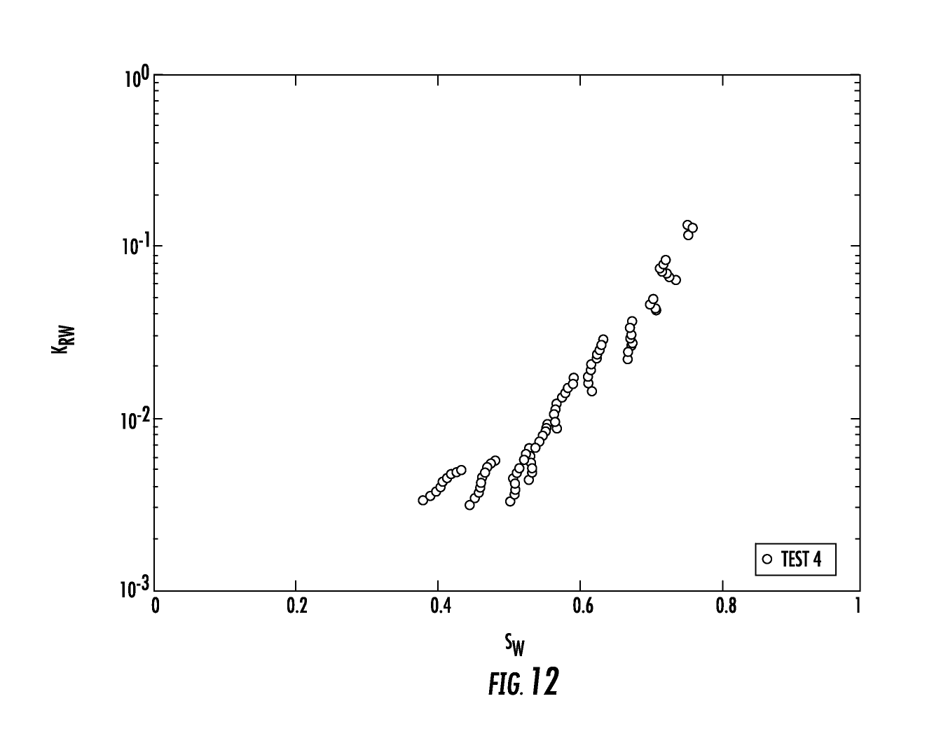

FIG. 11 is a graph that shows the obtained water relative permeability for two-phase study Test 3, where the gas is being injected at 3.78 psig. In this figure, the shown relative permeability data correspond to the middle 20 cm section of the core (e.g., ˜20 cm-40 cm of the core), for 7 different time intervals; this leads to 60 total data points. From this test relative permeability is obtained for saturations between 0.3 and 0.7, with the relative permeabilities being between 10⁻³ and 10⁻¹. The overall data looks like a normal relative permeability curve obtained from Berea (comparisons will be shown later). Importantly, this measurement took only about 1 day to obtain, which is much faster than achievable using conventional steady state techniques to measure relative permeability.

In FIG. 11, the overall curve is generally continuous. In particular, from each time interval there are 10 points corresponding to saturations and fluxes at 2 cm spatial intervals. These 10 points form a “Γ” shape. This is because as one heads downstream (or down column) both the flux and the saturation increase. Near the top of the 20 cm interval, the flux (which in turn becomes the relative permeability) increases faster than the saturation—this forms the vertical leg of the “Γ” shape; near the bottom the saturation increases faster than the flux—this forms the horizontal top of the “Γ” shape. This shape is most representative for the data around a saturation of 0.5 (this is for time interval 1123 and 1850 min). For earlier times (and higher saturations and fluxes), the vertical shape is prevalent over the top part, and for later times (and lower saturations) the horizontal top is prevalent.

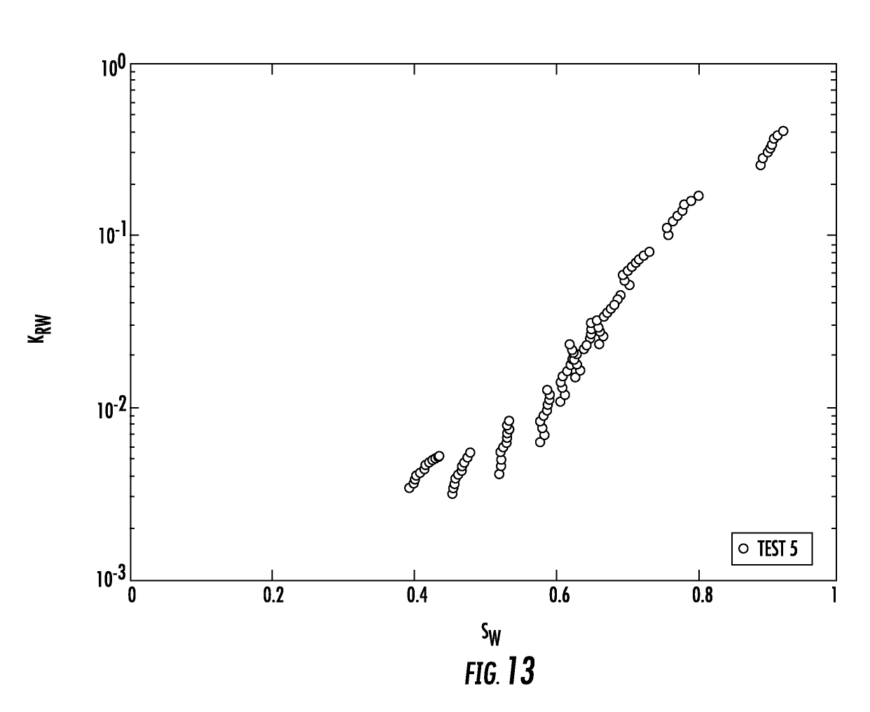

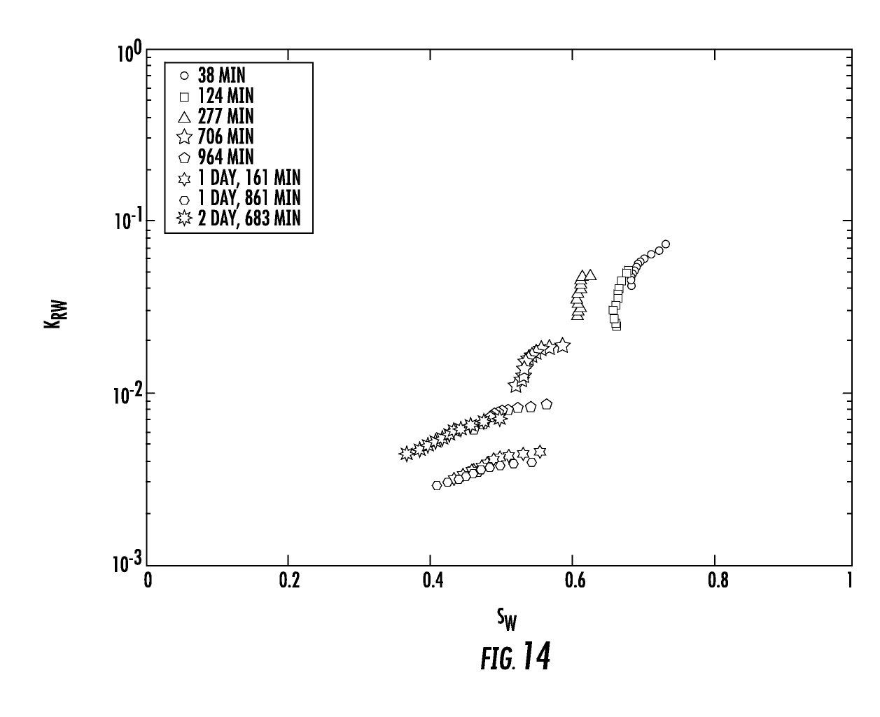

FIG. 12 is a graph that shows the obtained water relative permeability for two-phase study Test 4. FIG. 13 is a graph that shows the obtained water relative permeability for two-phase study Test 5. The data shown in FIGS. 12 and 13 show that at intermediate and high saturations, the curvature of the data line up smoothly together to form a single relative permeability curve. However, for the later time interval measurements, which correspond to lower saturations (see FIGS. 8 and 9), the structure of the relative permeability data shifts from following the overall curve to vertical lines. These are essentially the vertical part of the Γ shape as discussed earlier.

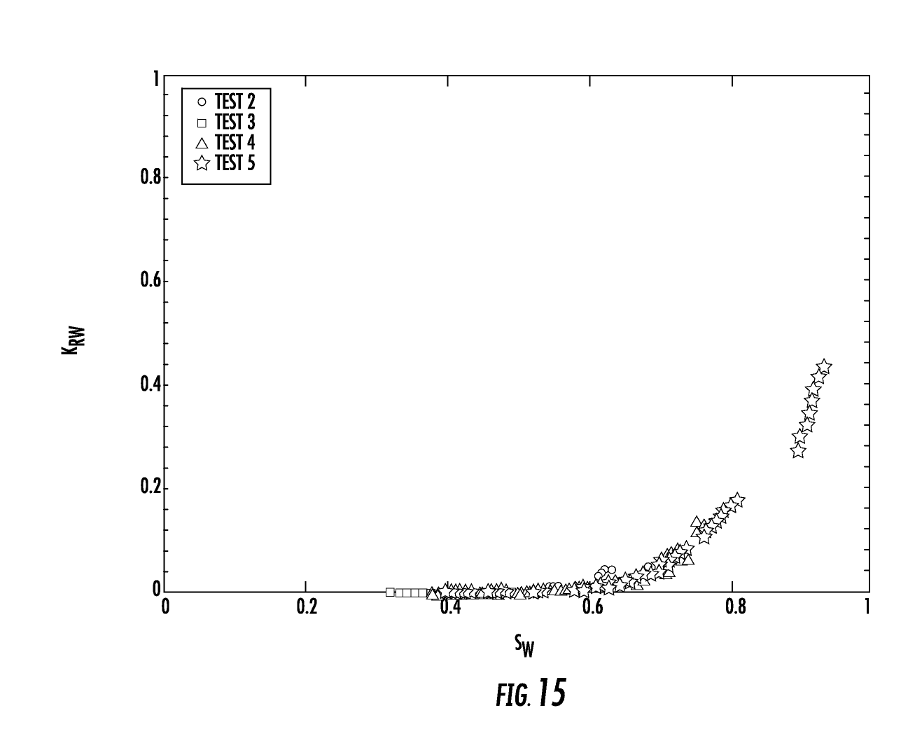

FIG. 14 is a graph that shows the relative permeability data obtained for two-phase study Test 2, which used the lowest gas injection pressure. Here the curve, while in the same overall position, is much more disjointed than the curves at higher gas injection pressures (see FIGS. 11-13). Looking closer at the structure for individual time intervals, the gamma shape is still observed, with some intervals showing the vertical leg of the gamma shape, and the later times showing the horizontal top. From the saturation measurements, this lowest pressure is the one with the highest potential capillary effects.

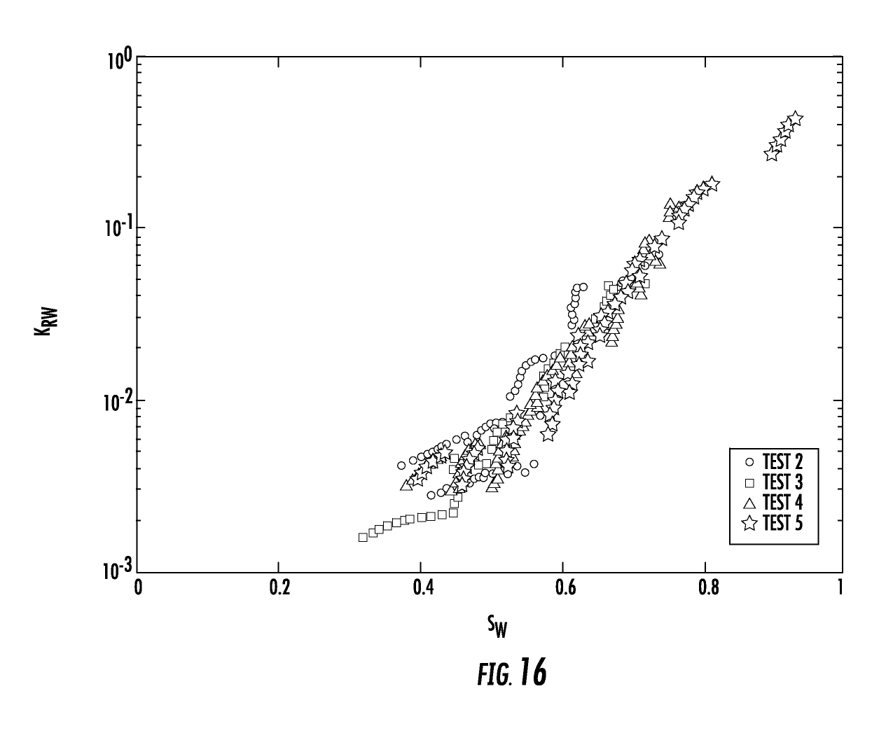

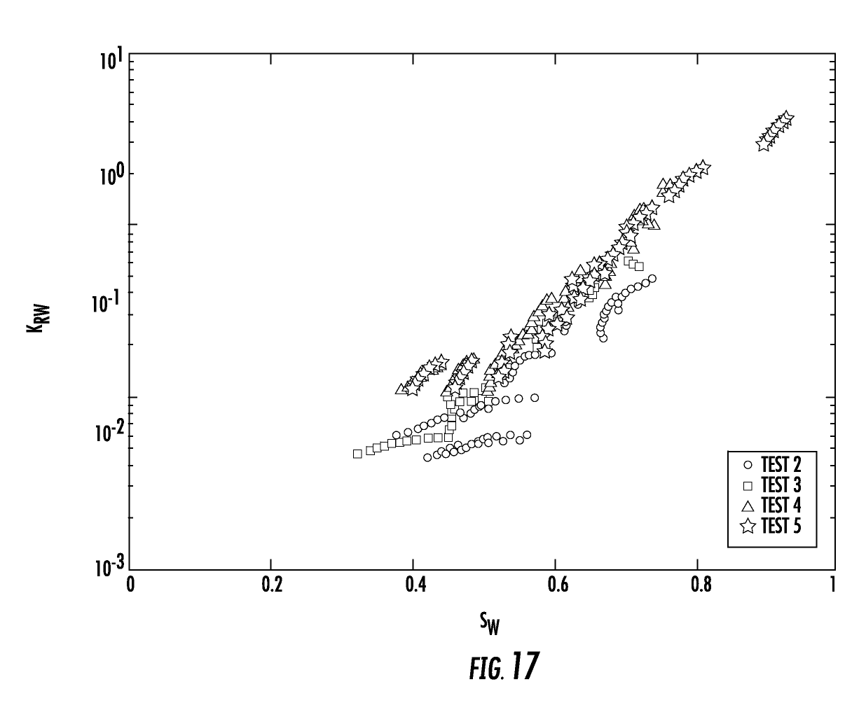

FIG. 15 is a graph that shows all the relative permeabilities shown in FIGS. 11-14 in a single plot on a linear scale. FIG. 16 is a graph that shows all the relative permeabilities shown in FIGS. 11-14 in a single plot on a log scale as a function of water saturation. On the linear scale, the relative permeabilities line up very well, with the measurements done at the highest gas pressure (two-phase study Test 5) providing data to the highest saturations. On the log scale, slight differences between the Tests can be observed, most notably at low saturations, although the overall structure is a single relative permeability curve. This shows the robustness of the techniques for obtaining relative permeabilities from unsteady state saturation profiles described herein, as long as the injected gas pressure is high enough to force the water down the core, the relative permeability will be accurate—there is no need to optimize for a particular pressure.

### Discussion

### Gas Pressure Gradient

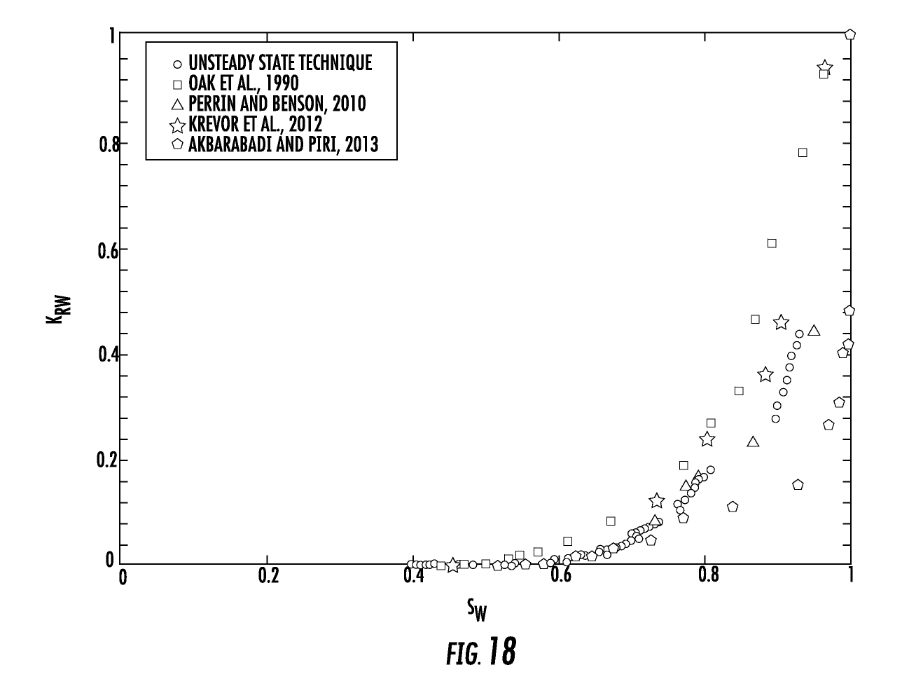

As described above, previous studies obtained relative permeabilities in sandpacks through gravity drainage experiments. However, these same studies ignore or neglect the gas pressure gradient due to its negligible values compared to gravitational gradient (Sahni, Burger, and Blunt 1998; DiCarlo, Akshay, and Blunt 2000; Dicarlo, Sahni, and Blunt 2000; Hassan Dehghanpour and DiCarlo 2013; H. Dehghanpour and DiCarlo 2013; Kianinejad et al. 2014). For permeable rocks, however, the gas pressure gradient term cannot be ignored or neglected and instead should be included in the relative permeability calculations. FIG. 17 is a graph that shows water relative permeability calculated based only on fluid gravity as a driving force (i.e., neglecting both capillary and gas pressure gradients). For example, with reference to FIG. 17, using data from two-phase study Tests 2-4 described above, the water relative permeability was calculated based on only considering fluid gravity while neglecting capillary pressure and gas pressure gradients. The data shown in FIG. 17 have values larger than one which clearly cannot be correct based on the definition of relative permeability. The reason for such behavior is in fact not considering gas pressure gradient, which is significant in two-phase study Tests 2-5; while capillary pressure gradients are negligible as explained earlier. Moreover, comparing FIGS. 16 and 17 shows that once the gas pressure gradients are incorporated in relative permeability calculations, all the relative permeabilities from different experiments line-up together and form a single relative permeability curve. In addition, the scatter of the data shown in FIG. 17 decreases in FIG. 16, and the relative permeability values drop to below 1. Getting a single relative permeability curve from different experiments is another way to confirm that the gas pressure gradient should be considered in the calculations, as the relative permeability does not depend on gas injection pressure and is a single curve for each rock.

### Nature of the Structure in Relative Permeability Curves

As described above, for each time interval, the set of data points that is obtained tends to show a gamma shape. This shape is most likely caused by neglecting of capillary forces (e.g., the capillary pressure gradient) when calculating relative permeability. The gamma shape also provide insight on conditions when ignoring capillary forces is a reasonable assumption. Taking a step back, essentially each relative permeability point is the measured flux divided by the pressure gradient, plus some constant normalizing factors (e.g., viscosity and permeability). In the techniques described herein, the flux is obtained from integrating the saturation changes, but for the pressure gradient it is assumed this is constant in time and space. In actuality, the pressure gradient is not constant in time and space, the viscous and capillary gradients do change. As shown in the simulations and discussed above, changes in the viscous gradient are small as long as the data position is behind the main front, which is already a criterion. Changes in capillary pressure are potentially much greater. As described above, if the predetermined criteria (e.g., (i) saturation profiles are spatially uniform and (ii) saturation gradients are small) are met, the capillary pressure gradient is a small fraction of the overall gradient. Changes in the capillary pressure gradient may be enough to create the structure of the data that is observed.

In terms of the capillary pressure gradient, it is possible obtain a rough estimate from the saturation gradient, but difficult to get an exact value. This is because of natural variations in the saturation due to heterogeneities in the sandstone, and taking gradients of these variations can only be approximate. This is why the predetermined criteria were developed, i.e., to determine the conditions under which the capillary pressure gradient can be discounted. Even under conditions meeting the predetermined criteria, there can be systematic variations of the capillary gradient, and that these systematic variations end up affecting the measured relative permeabilities.

These systematic variations may lead to the gamma shape in the data for each time interval. This is because ignoring the capillary forces can result in an under-estimated relative permeability as the capillary forces act to lower the overall gradient, and the assumption is that the gradient does not have these forces. For each time interval, since the highest relative permeability data are at the knee of the gamma shape, these are likely to have the smallest capillary forces and therefore likely to be the least biased when capillary forces are ignored. The bottom of the leg of the gamma shape correspond to the lower flux portions of the core (e.g., points near the top of the core where the inlet capillary gradient is highest). Going downward in the core increases the flux (and recorded relative permeability) and reduces the inlet capillary gradient. This is the case for a while, but going further downward, the saturation starts to increase much faster than the flux, producing the top part of the gamma shape. Here the saturation is higher than expected due to the increasing capillary gradient toward the exit end of the core. This again causes an underestimation of the relative permeability data using the techniques described herein. The knee in the gamma shape is the sweet spot, where the capillary gradient is at a minimum, and thus are the most accurate relative permeabilities.

As shown in FIGS. 11-14, depending on the flow rate, and the time interval, different parts of the gamma shape are observed. For instance, in FIG. 11, early data (high saturation) are more affected by the inlet boundary, while late data (low saturation), the capillary gradients from the outlet play more of a role. But in general, the deviations in the relative permeabilities for one time interval of data are at most a factor of 50% from the general curve. This is true even at the greatest distance away from the knee for the inlet and the outlet. This shows that the capillary forces can be safely ignored as long as one remains in the predetermined criteria—going further out (e.g., closer to the outlet and inlet regions of the core) and stretching the criteria produces much greater deviations. This also can be seen in the difference between FIGS. 11-14. In FIG. 14, the capillary gradient is the highest, leading to the largest gamma shape and variations. FIG. 16 shows that when all of the data are brought together that one curve is obtained.

### Water Relative Permeability of Berea Sandstone in Literature

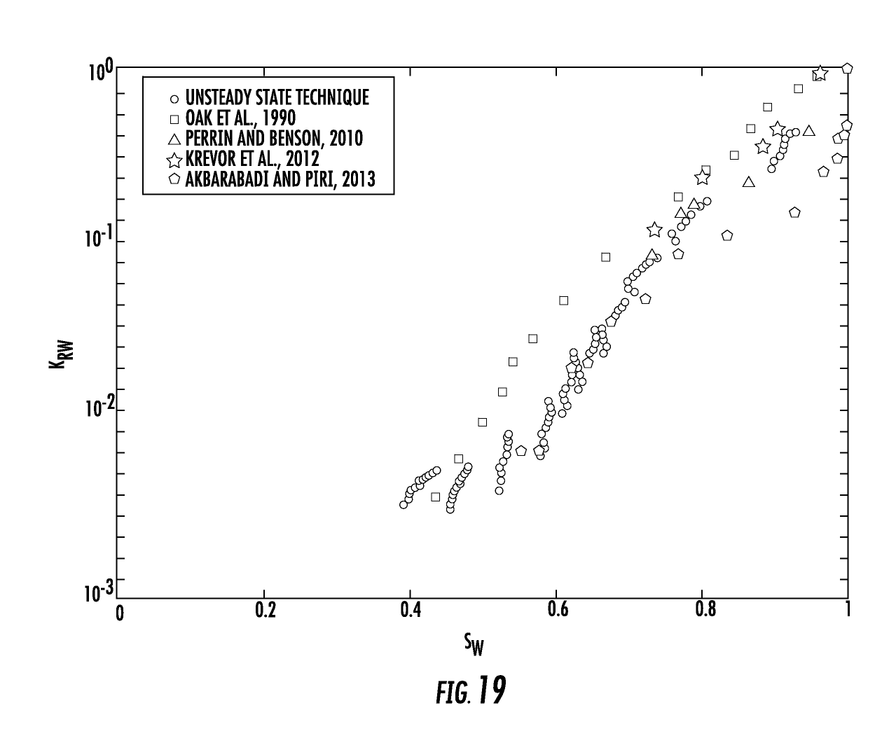

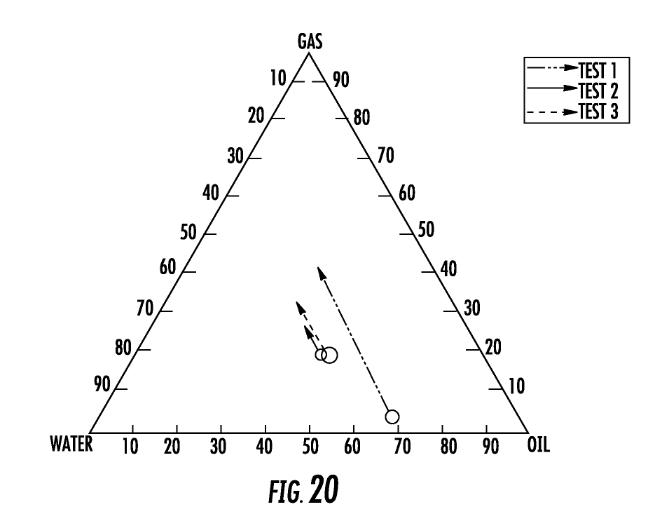

To further validate the techniques for obtaining relative permeability from unsteady state saturation profiles as described herein, the data obtained in two-phase study Tests 2-5 is compared to other experimental water relative permeability data measured on Berea samples. FIG. 18 is a graph that shows four sets of published water relative permeability data of Berea core samples using conventional steady-state techniques along with the water relative permeability measured using the unsteady-state techniques described herein (Oak, Baker, and Thomas 1990; Perrin and Benson 2010; Krevor et al. 2012; Akbarabadi and Piri 2013) on a linear scale. FIG. 19 is a graph that shows four sets of published water relative permeability data of Berea core samples using conventional steady-state techniques along with the water relative permeability measured using the unsteady-state techniques described herein (Oak, Baker, and Thomas 1990; Perrin and Benson 2010; Krevor et al. 2012; Akbarabadi and Piri 2013) on a log scale. FIG. 18 indicates that the measured relative permeability according to techniques described herein is in great agreement with the data measured by steady-state method by others over high saturation regions. To show the similarity of the obtained relative permeability in this work to the data reported by others at low saturations, FIG. 19 shows the same data on log scale. From FIG. 19, it can be seen that the relative permeabilities obtained in this work agrees well with the literature data on Berea core samples over the entire saturation space. Additionally, the unsteady state techniques described herein yield relative permeability much faster than the conventional steady-state methods, which is one advantage of the techniques described herein. For example, FIGS. 6-9 show that the relative permeabilities measured according to the techniques described herein were obtained in less than two days, as opposed to other methods which take much longer time. In addition, using the techniques described herein it is possible to obtain results in relative permeabilities over a range of saturations, while the steady-state methods results in only a limited number of points on the relative permeability curve. Moreover, the techniques described herein enables one to obtain small relative permeabilities on the order of 10⁻³-10⁻⁴ in a short period of time.

### Conclusions

The techniques described herein allow calculation of relative permeabilities quickly over a large saturation space and provides many points on relative permeability curve in a short period of time. Additionally, the calculated relative permeabilities have high accuracy due to direct measurement of relative permeabilities from unsteady-state in-situ saturations without any assumptions or interpretations. In addition, it is assured that the data are not compromised by capillary entry and end effects. Further, extremely small relative permeabilities (e.g., magnitude of 10⁻⁴-10⁻⁵) are possible to obtain using techniques described herein due to “pulling” effect of gravity rather than “pushing” effect of flooding experiments. Also, the techniques described herein include the estimated gas pressure gradient into the relative permeability calculations by removing the pressure drops at the outlet of the core due to capillary effects. Further, no prior knowledge of P_{c} curve is needed because it does not play a significant role and is negligible if the mentioned criteria are met.

Determining Relative Permeability from Unsteady State Saturation Profiles in Three-Phase Systems

Relative permeability of oil in water-wet rocks in three-phase systems depends on water saturation in addition to oil saturation. This dependency results in infinite possibilities of combinations of phase saturations in three-phase space, making measurements of three-phase relative permeability difficult and time consuming. Therefore, measurements of changes in three-phase relative permeability in three-phase space are scarce. On the other hand, the existing three-phase relative permeability models for predicting these changes (e. g. hysteresis) are usually complicated and require several parameters. As described below, three-phase oil relative permeability curves are measured along different saturation paths by developing a gravity drainage technique that works in consolidated sandstone (e.g., permeable rock). The experiments consist of measuring in-situ saturations along a 2-ft long vertical Berea sandstone core at different times using computed tomography (CT) technique during gravity drainage experiments, along three saturation paths over three-phase space. Three-phase oil relative permeability are then obtained directly from the transient in-situ saturations measured during each experiment. The data show that at the same oil saturation, the three-phase oil relative permeability varies significantly depending on the saturation path in three-phase space. From these measurements, standard and simple Corey relative permeability model is used to fit the results. It is found that each saturation path exhibits a different residual oil saturation, and that the Corey model matches the data well once the residual oil saturation is given correctly for each saturation path, while keeping all the other parameters constant. The results suggest that, contrary to previous results, three-phase oil relative permeability in water-wet media is only a function of oil saturation, if the residual oil saturation changes are accounted for accordingly. In other words, to correctly model three-phase relative permeability, the correct residual saturations can be used for each saturation path (history).

As described below, gravity drainage methods can be extended to using crude oil instead of refined oil, and to using consolidated rocks (e.g., permeable rocks) instead of sandpacks. Similar to the two-phase experiments described above, experiments were conducted in a 2 ft-long vertical Berea core, and three-phase relative permeability data-set along different saturation paths was obtained. This method benefits from several advantages over conventional methods such as steady-state or JBN (Johnson et al., 1959). For example, this technique allows the fluids saturations to change naturally, as opposed to steady-state method, while it is much faster and less expensive. In addition, this technique obtains the relative permeability of each phase directly from the measured transient in-situ saturations, as opposed to JBN method. A fluid (e.g., gas) is injected from the top of the core, while allowing the oil and water phases to drain by gravity. Simultaneously, a computed tomography (CT) technique (e.g., NDT device) is used to measure in-situ saturations as a function of space and time. By controlling the fluid fluxes of water, three-phase relative permeabilities along three saturation paths over the three-phase saturation space are measured, and the effect of saturation path on three-phase relative permeability are quantified. In the examples below, crude oil (as opposed to refined oil) was in the measurements. It is shown that relative permeability to crude oils can be different from that of refined oils in the same porous media (Delshad et al., 1987; Delshad and Pope, 1989; Dria et al., 1993; Zhang et al., 2009).

Materials and Methods

Porous Media and Fluids

In the examples, a 2-ft long Berea sandstone core with 300md permeability was used. The porosity of the core was measured as 0.21±0.04 along the core using CT scanning technique.

A 10 wt % sodium bromide (NaBr) aqueous solution was used as the brine, a crude oil from a Malaysian oil field was used as the oil phase, and air was used as the gas phase. The density and viscosity of the brine was measured as 1069 kg/m³ and 1.23 cp, respectively, while the crude oil had 30 cp viscosity and 958 kg/m³ density. The physical properties of the working fluids are summarized in Table 1.

TABLE 1
Physical properties of the fluids used in the experiments

| Fluid | Density (kg/m³) | Viscosity (cp) |
|---|---|---|
| Brine (1 wt % NaBr) | 1069 | 1.23 |
| Crude oil | 958 | 30 |
| Air | 1.2 | 0.02 |

Experimental Procedure

Three experiments (also referred to below as three-phase study tests) along three saturation paths were conducted to quantify the effect of saturation path on three-phase oil relative permeability. To do so, the core was initialized at different initial saturations for each experiment. As described above, simply opening the entry end and the exit end of a 2-ft long water saturated Berea rock (e.g., permeable rock) to the atmosphere does not allow flow to occur; this is mainly due to higher capillary forces in rocks than in sands. In order to allow the fluids inside the core drain by gravity, a fluid (e.g., gas) is injected from the top (e.g., the entry end) of the core at a constant injection pressure for all three experiments, while leaving the bottom of the core open to the atmosphere. In addition, to control the saturation path of each experiment over the three-phase saturation space, water influxes were controlled at the top while injecting gas.

Specifically, gas was injected from the top of the core, at the constant pressure of 8.96 psig during the entire time of the experiment for all experiments. In addition, water was injected at a different flow rate for each experiment to maintain a certain water saturation. For three-phase study Test 1, the core was initialized at residual water and residual gas by injecting oil from the bottom of a water-flooded core. Test 1 was started by injecting gas from the top at 8.96 psig, and letting the core drain by gravity. At the same time, the core was CT scanned along the core at 2-cm intervals to measure the in-situ saturations along the core at different times. After completing Test 1, the core was prepared for three-phase study Test 2 by injecting oil and water from the top for several hours until the saturations did not change along the core any further (steady-state was reached). Test 2 was started by stopping the injection of oil and starting injecting gas at the same pressure as Test 1 (8.96 psig), while keeping injecting water from the top at 0.1 cc/min for the entire experiment. Like Test 1, the core was scanned during the experiments at 2-cm intervals to measure the in-situ saturations. Three-phase study Test 3 was conducted in the same way as Test 2, but the water was injected at the flow rate of 0.05 cc/min. Table 2 lists the details of each experiment.

TABLE 2
Two-phase experiments with different
initial and conducting conditions

| | Water injection rate | Gas injection pressure | Duration of test |
|---|---|---|---|
| Test | (cc/min) | (psig) | (days) |
| 1 | 0 | 8.96 | 8.6 |
| 2 | 0.1 | 8.96 | 10.7 |
| 3 | 0.05 | 8.96 | 11.7 |

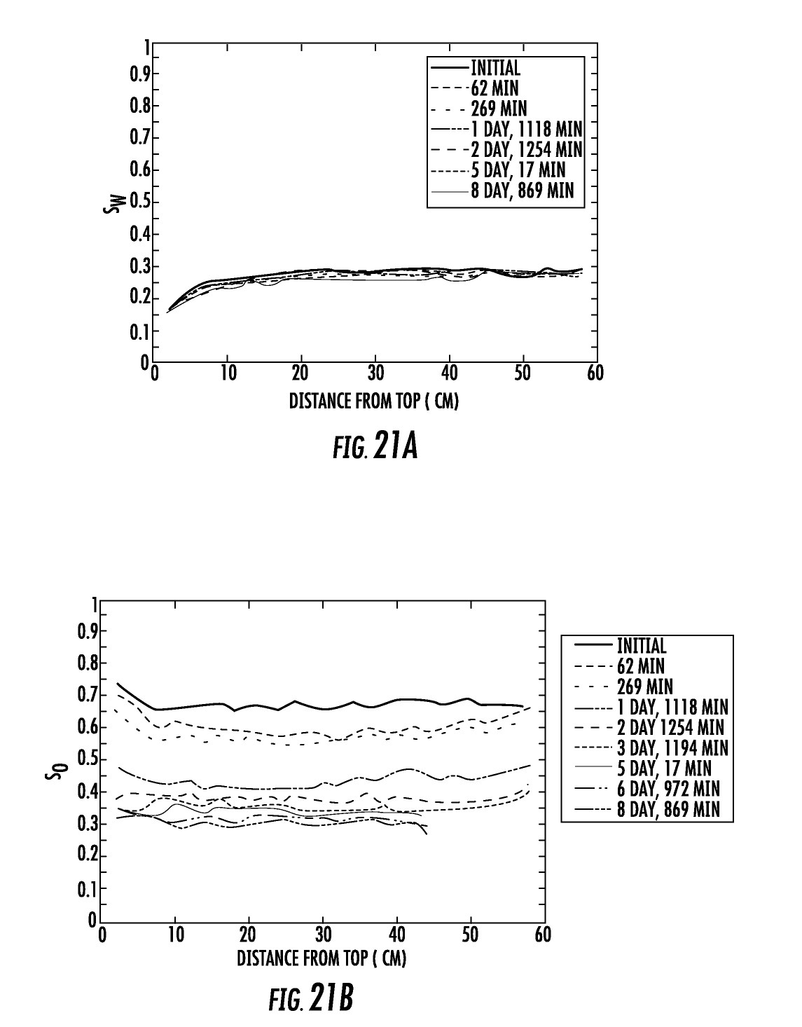

FIG. 20 illustrates the saturation path of three-phase study Tests 1-3 on three-phase saturation space.

Obtaining Relative Permeability from In-Situ Saturations

As described above, it is possible to obtain relative permeabilities from in-situ saturations during gravity drainage in sandpacks. In particular, it is possible to re-arrange the Darcy equation as:

$${k}_{n} = \frac{{u}_{i} {u}_{i}}{k ( \frac{d {P}_{i}}{d z} + {ρ}_{i} g )} \qquad ( 8 )$$

Using material balance equation, fluid fluxes at 2-cm intervals along the core are obtained from two consecutive in-situ saturation profiles. As described above, at the middle portion of the core, e.g., far from the entry end and exit end of the core, the saturations are spatially uniform and have small saturation gradients. These conditions are referred to as the predetermined criteria above. Therefore, capillary pressure gradients are negligible in this section of the sandpack, and relative permeability can be obtained by only considering the gravitational gradient as the only driving force. However, as described above, for permeable rocks where capillary forces are higher, it is not possible to neglect the gas pressure gradient because gas is injected into the core, and instead, the gas pressure gradient is accounted for.

In particular, as described above, the techniques described herein are extended to permeable rocks by injecting gas from the entry end of the core to allow fluids drain from the core by gravity. As described above, in consolidated rocks, the gas pressure gradient should be included in the relative permeability calculations in addition to gravitational gradient, while the capillary pressure gradient was still negligible at the sections of the core where the saturation gradient was small.

The techniques for obtaining relative permeability from unsteady state saturation profiles described above for two-phase system can be extended to obtain three-phase relative permeability during three-phase gravity drainage experiments in consolidated rocks. Three-phase oil relative permeability at the middle 20-cm section of the core (z=20-40 cm) can be obtained, where the saturation gradients are small and capillary gradients are negligible. In the calculations, the estimated gas pressure gradient in the middle of the core is used, by discarding the pressure drops at the inlet and outlet of the core due to capillary entrance and end effects.

Results

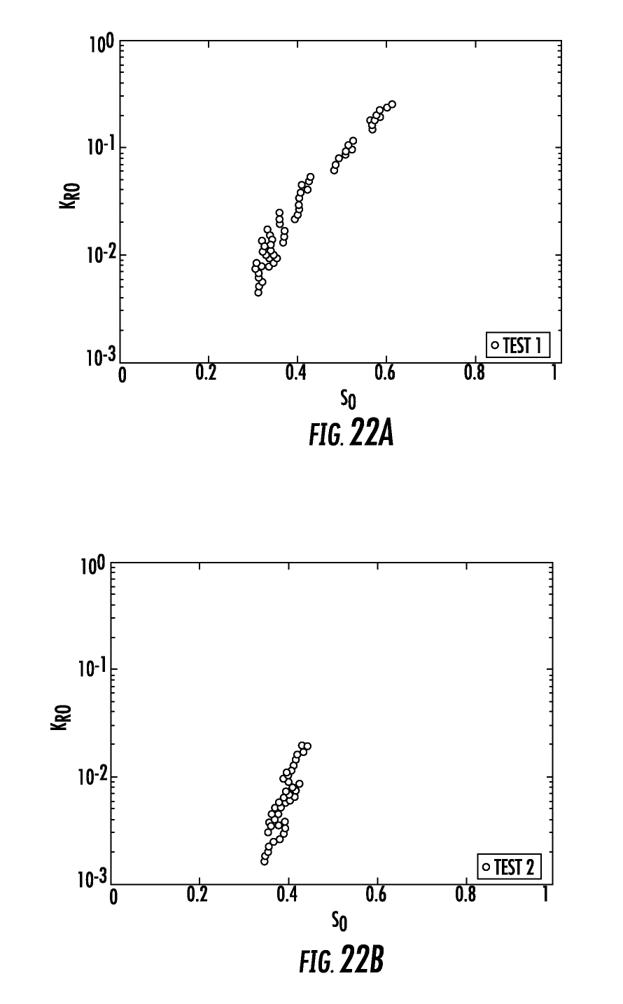

In three-phase study Tests 1-3 described below, saturation profiles were measured, and then the relative permeability data is obtained for each experiment from their respective saturation profiles. FIG. 21A is a graph that show the water saturation profile along the core during three-phase system Test 1. FIG. 21(b) is a graph that show the oil saturation profile along the core during three-phase study Test 1. In these Figures, the saturation profiles along the entire core are uniform with small gradients

$$( \frac{Δ {S}_{o}}{Δ z} < 0.006 {cm}^{- 1} ) ,$$

i.e., meeting the predetermined criteria described above. These small saturation gradients meet the criteria for neglecting capillary pressure gradient. Therefore, relative permeabilities can be obtained based on only gravitational gradient^{(ρ}_{ω}g) and gas pressure gradient

$$( \frac{d {P}_{g}}{d z} )$$

as described above. FIG. 21A shows that, the water saturation along the core does not change during the entire time of the Test 1, while FIG. 21(b) shows that oil saturation uniformly decreases from S₀≈0.7 to S₀≈0.3. Since the water saturation along the core does not change during Test 1, the measured value (S_{w}≈0.27) is considered as the residual water saturation for the core sample. This value can be used to model the measured relative permeability data using Corey model.

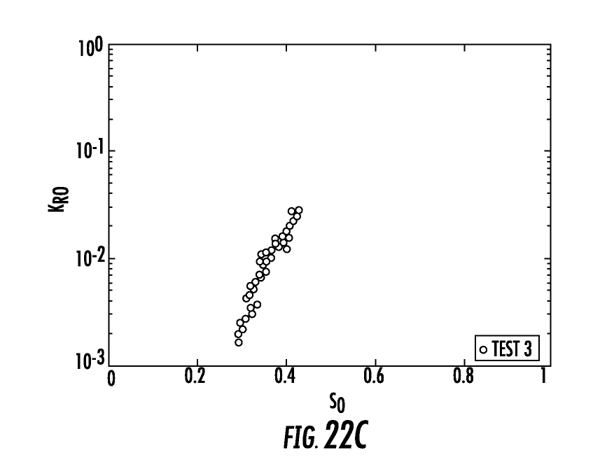

FIG. 22A is a graph that shows the three-phase oil relative permeability data obtained from three-phase study Test 1. FIG. 22(b) is a graph that shows the three-phase oil relative permeability data obtained from three-phase study Test 2. FIG. 22C is a graph that shows the three-phase oil relative permeability data obtained from three-phase study Test 3. The data shown in FIGS. 22A-22C demonstrate that measurement of relative permeability using this method provides many data points on relative permeability curve in a short period of time, as opposed to other methods such as steady-state methods. Additionally, the relative permeability data obtained using the unsteady state technique described herein are obtained in less than two weeks of running time (see Table 2). In addition, FIGS. 22A-22C show that the three phase oil relative permeability can be significant even at moderate saturations. For instance, the data in FIG. 22A shows that kₘ≈0.27 at Sₘ=0.61. On the other hand, the relative permeability data shown in FIGS. 22A-22C are also found to much smaller values of kₘ≈10⁻³.

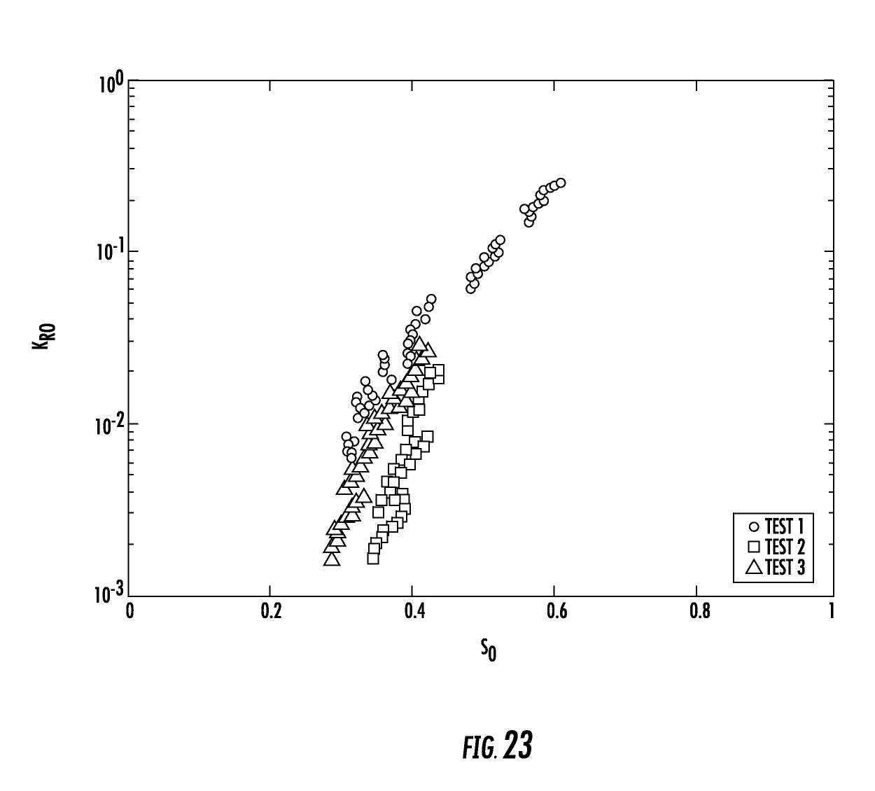

To demonstrate the differences of the three oil relative permeability curves obtained from three-phase study Tests 1-3, FIG. 23 is a graph that shows plots all of the data shown in FIGS. 22A-22C in a single plot. FIG. 23 shows that, the relative permeability curves obtained for each saturation path are different from one another. In FIG. 23, at the same oil saturation, the oil relative permeability varies significantly (up to one order of magnitude) depending on the saturation path in three-phase space. For instance, at S₀=0.35, kₘ≈0.014, for three-phase study Test 1, while kₘ≈0.0017 and kₘ≈0.0075 for three-phase study Tests 2 and 3, respectively. However, these differences reduce as the oil saturation increases. In addition, the relative permeability data shown in FIG. 23 extend to different residual saturations, for different Tests.

Discussion

There exist several conventional relative permeability models for predicting relative permeability and its hysteresis effects. However, these conventional models are often complicated with several fittable parameters and can be hard to use for practical purposes. Thus, techniques are described herein for modeling three-phase relative permeability changes over three-phase space, while taking advantage of standard and simple relative permeability models. Below, the performance of Corey type model is compared against experimental data. In particular, the relative permeability data shown in FIG. 23 exhibit a systematic change in the measured relative permeabilities and their respective residual oil saturation. In FIG. 23, as the residual saturation of each curve decreases, its respective oil relative permeability curve increases. Therefore, to match the experimental data, the same residual water saturation is used while using different residual oil saturations for each saturation path. The Corey-type model used herein is:

$${k}_{cis} = {C ( \frac{{S}_{o} - {S}_{or}}{1 - {S}_{wr} - {S}_{or}} )}^{{n}_{r}} \qquad ( 9 )$$

where is C a fitting constant, S is saturation, and nₐ is the oil exponent.

The measured relative permeability data from three-phase study Test 1 is matched to find C and nₐ. The Corey model fits the oil relative permeability data for three-phase study Test 1 with C=0.55, Sₘ=0.27, nₐ=3, and

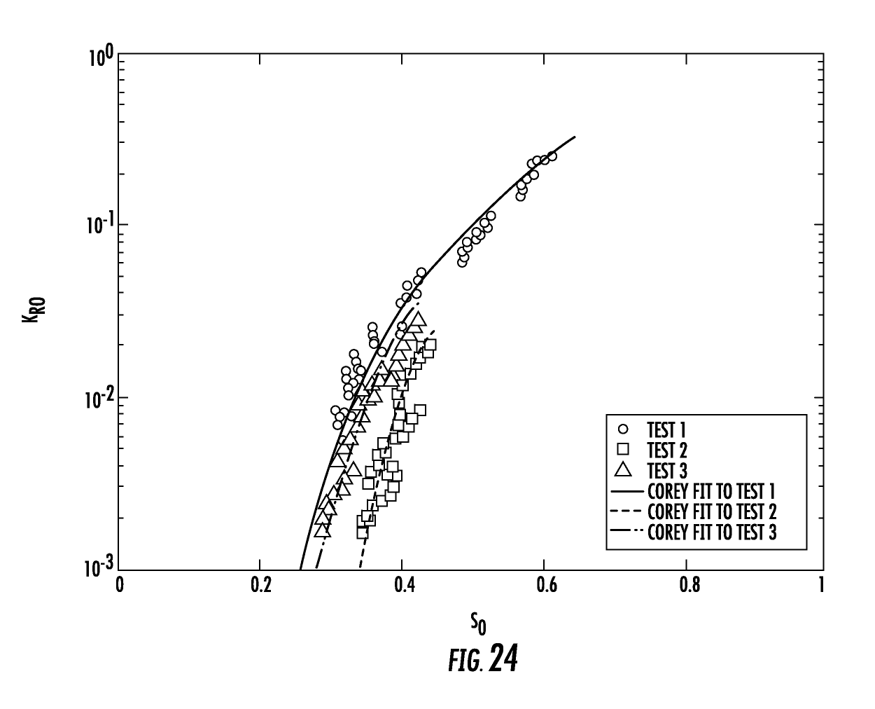

Sₘ=0.195. The residual water saturation used in the model was experimentally measured from three-phase study Test 1, where no water was injected to the core. Therefore, it is assumed that the measured values are residual water saturation. To fit the other two relative permeability curves, all the Corey-type model parameters are kept constant, and only change residual oil saturation to fit the experimental data. Table 3 shows the Corey-type parameters used to fit the experimental data. FIG. 24 is a graph that shows the measured data of FIG. 23 and their respective Corey-type fits. FIG. 24 shows that using different residual saturation for each experiment (saturation path), while keeping the other parameters constant, the data can be fit quite well.

TABLE 3
Corey-type model parameters used for matching
measured three-phase oil relative permeability

| Test | C | S_{wr} | nₒ | Sₒᵣ |
|---|---|---|---|---|
| 1 | 0.55 | 0.27 | 3 | 0.195 |
| 2 | 0.55 | 0.27 | 3 | 0.29 |
| 3 | 0.55 | 0.27 | 3 | 0.22 |

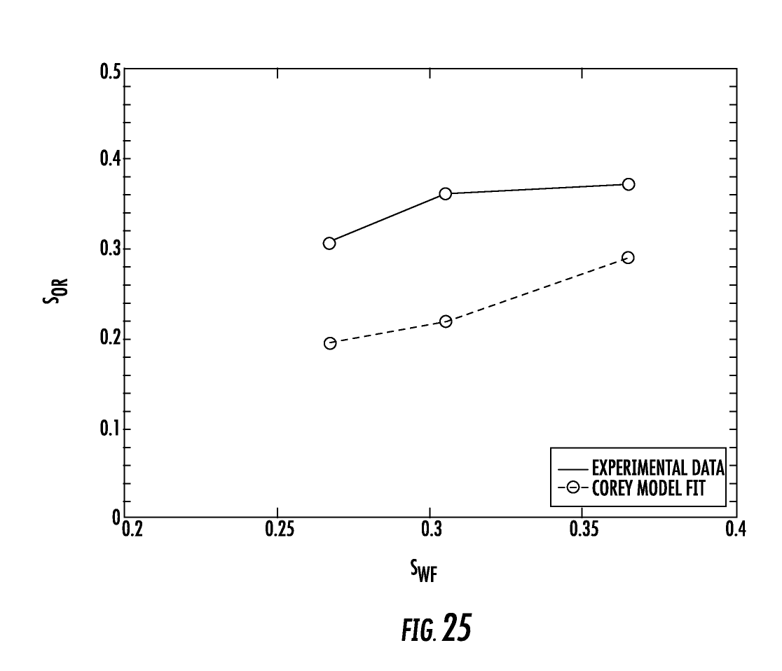

As shown above, the residual oil saturation is different for each saturation path in three-phase space. FIG. 25 is a graph that shows the residual oil saturation as a function of final water saturation of the system for three-phase study Tests 1-3. The top, solid curve shows the measured residual oil saturation as a function of measured final water saturation of each experiment, while the lower, dashed curve shows the used residual oil saturation in Corey model to fit the experimental data as a function of measured final water saturation of each experiment. The two curves shown in FIG. 25 exhibit a large difference in residual oil saturations at the same water saturation. This difference is likely because of the insufficient experimental time to achieve the correct residual oil saturation during each experiment. However, the overall trend in the two curves shown in FIG. 25 is the same; increase in water saturation increases the residual oil saturation of the system. In FIG. 25, the solid curve shows the experimental residual oil saturation (obtained after only less than 12 days of drainage) while dashed curve shows the residual oil saturation used in Corey model to fit the data, both as a function of measured final water saturation of the system during three-phase study Tests 1-3.

As described above, different saturation paths in three-phase space result different oil relative permeability curves which can be as high as an order of magnitude. Here, the measured three phase oil relative permeability data is plotted as a function of normalized mobile oil saturation as for each experiment:

$${S}_{attNorm} = \frac{{S}_{o} - {S}_{or}}{1 - {S}_{wr}} \qquad ( 10 )$$

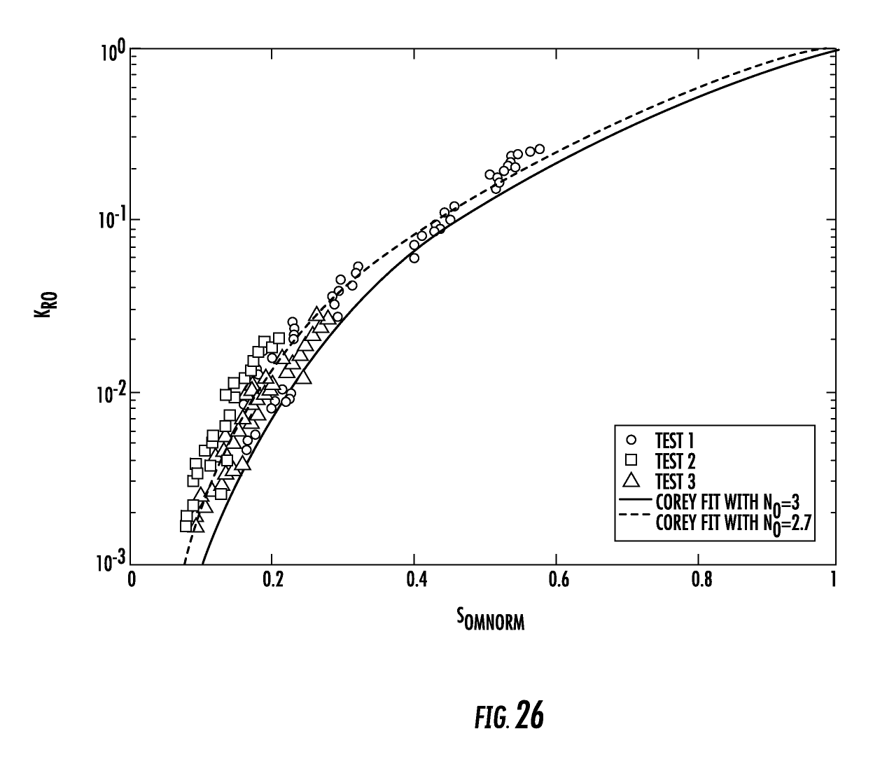

The results are shown in FIG. 26, which is a graph that shows measured three-phase oil relative permeability as a function of normalized oil saturation and the corresponding Corey model fit. FIG. 26 shows that, once the relative permeabilities are plotted as a function of normalized saturation of mobile fraction of oil phase, all the relative permeability data of each experiment with different saturation path lie on top of each other and form a single relative permeability curve. This behavior confirms that the differences in three-phase oil relative permeability along different saturation paths are the result of change in residual oil saturation. Otherwise, all three-phase relative permeability curves obtained from different saturation paths are identical.

To fit the resulted three-phase oil relative permeability curve shown in FIG. 26 with the Corey model, equation (9) was used with zero residual water and oil saturations (Sₘ=0, Sₘ=0) since the saturation axis is normalized. In addition, the fitting constant C=1 was used. The solid curve in FIG. 26 shows the Corey model with the above values and nₐ=3, as it was used in FIG. 24. In FIG. 26, the solid curve slightly underestimates the normalized relative permeability data. However, the dashed line which shows the Corey model with nₐ=2.7 (and Sₘ=0, Sₘ=0, C=1) fits the normalized data well.

It is important to mention that the fitting constant C=1 in curves shown in FIG. 26, since all the normalized saturation is the mobile fraction of the oil phase and its relative permeability should approach to 1 theoretically, as opposed to previous which this value was used as C=0.55.

Based on the experimental results, a number of conclusions can be drawn. First, three-phase oil relative permeability varies significantly, depending on the saturation path and water saturation. The residual oil saturation depends on the saturation path over three-phase space and can change measureable amounts. Three-phase oil relative permeability can be fit only a function of oil saturation, if the residual oil saturation for different saturation paths is treated accordingly. Corey model fits the experimental data when correct residual oil saturation in used for each saturation path. Residual oil saturation is the key parameter for modeling three-phase oil saturation over three-phase space.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for obtaining relative permeability from unsteady state saturation profiles, comprising:
injecting a first fluid into a core;
at each of a plurality of times, measuring a respective saturation profile of a second fluid along the core;
estimating one or more parameters related to conditions of the core directly from the respective saturation profiles; and
calculating the relative permeability using the one or more parameters.

2. The method of claim 1, wherein the first fluid is injected at a pressure greater than an entry capillary pressure of the core.

3. The method of claim 1, wherein the one or more parameters comprise at least one of a fluid flux, a gas pressure gradient, or a capillary pressure gradient.

4. The method of claim 1, wherein the one or more parameters are estimated for a region of the core where the respective saturation profiles meet predetermined criteria.

5. The method of claim 4, wherein the predetermined criteria comprise the respective saturation profiles in the region of the core being spatially uniform and having small saturation gradients.

6. The method of claim 4, wherein the predetermined criteria comprise a capillary pressure gradient in the region of the core being less than a sum of a gas pressure gradient in the region of the core and a gravitational gradient.

7. (canceled)

8. (canceled)

9. The method of claim 4, further comprising neglecting a capillary pressure gradient when the respective saturation profiles meet predetermined criteria.

10. The method of claim 1, wherein the respective saturation profiles are measured using a nondestructive testing (NDT) technique.

11. (canceled)

12. The method of claim 1, wherein the first fluid comprises gas, or the second fluid comprises at least one of gas, oil, or water.

13. (canceled)

14. (canceled)

15. The method of claim 12, wherein measuring a respective saturation profile of a second fluid along the core comprises measuring a respective saturation profile of each of a plurality of fluids along the core, the fluids comprising water and oil.

16. The method of claim 15, further comprising injecting water into the core.

17. The method of claim 1, wherein the relative permeability is a multi-phase relative permeability.

18. The method of claim 1, wherein the core defines an entry end and an exit end, the first fluid is injected into the entry end of the core, and the second fluid drains by gravity from the exit end of the core.

19. (canceled)

20. (canceled)

21. The method of claim 1, wherein the core comprises permeable rock.

22. A system for obtaining relative permeability from unsteady state saturation profiles, comprising:
a pressure source configured to inject a first fluid into a core;
a nondestructive test (NDT) device configured to measure, at each of a plurality of times, a respective saturation profile of a second fluid along the core; and
a processor and a memory in operative communication with the processor, the memory having computer-executable instructions stored thereon that, when executed by the processor, cause the processor to:
estimate one or more parameters related to conditions of the core directly from the respective saturation profiles, and
calculate the relative permeability using the one or more parameters.

23. The system of claim 22, wherein the pressure source is further configured to inject the first fluid at a pressure greater than an entry capillary pressure of the core.

24. (canceled)

25. The system of claim 22, wherein the one or more parameters are estimated for a region of the core where the respective saturation profiles meet predetermined criteria, the predetermined criteria comprising the respective saturation profiles in the region of the core being spatially uniform and having small saturation gradients, or the predetermined criteria comprising a capillary pressure gradient in the region of the core being less than a sum of a gas pressure gradient in the region of the core and a gravitational gradient.

26-29. (canceled)

30. The system of claim 22, wherein the NDT device comprises a computed tomography (CT) imaging system.

31. (canceled)

32. The system of claim 22, wherein the pressure source comprises a gas pressure regulator.

33-41. (canceled)

42. A method for obtaining relative permeability from unsteady state saturation profiles, comprising:
receiving, using a computing device, a plurality of saturation profiles of a fluid along a core, each of the saturation profiles being measured at a different time, wherein the core comprises permeable rock;
estimating, using the computing device, one or more parameters related to conditions of the core directly from the saturation profiles; and
calculating, using the computing device, the relative permeability using the one or more parameters, wherein the one or more parameters are estimated for a region of the core where the saturation profiles meet predetermined criteria.

43-52. (canceled)
